(19) United States
(12) Patent Application Publication
(10) Pub. No.: US 2009/0326799 A1
(43) Pub. Date: Dec. 31, 2009

(54) Distributed Route Segment Maintenance and Hierarchical Routing Based on Physical Vehicle Criteria

(75) Inventor: Hubert W. Crook, Florence, MS (US)

Correspondence Address: BANNER & WITCOFF, LTD., 1100 13th STREET, N.W., SUITE 1200, WASHINGTON, DC, 20005-4051, US

(73) Assignee: ExpressPass Systems, Inc., Jackson, MS (US)

(21) Appl. No.: 12/145,953

(22) Filed: Jun. 25, 2008

(51) Int. Cl. G01C 21/36

(52) U.S. Cl. 701/201; 701/200

(57) ABSTRACT

A system and method to facilitate the creation, organization, maintenance and determination of traversable routes for vehicles traveling between an origin and a destination. Traversable routes are based on one or a plurality of route segments each containing criteria related to physical aspects of the segment, including maximum allowable physical limits of a vehicle. These route segments may be partially or completely joined via standardized node identifiers prior to route selection to allow additional level(s) of physical or other criteria to be stored in association with a plurality of route segments. Individual route segments, collections thereof, or complete routes may be maintained independently, or in a hierarchical manner whereby physical criteria or other data exist in associated layers. Traversable routes may be determined by the selection of complete routes, which may contain one or a plurality of associated segments, and span certain origins and destinations.

### BACKGROUND

Certain authorities, such as state highway administrations and municipalities, require that certain vehicles such as oversized or overweight trucks obtain a permit to travel within their jurisdictions.

However, these vehicles do not necessarily limit travel to only occur within a single jurisdiction, and often cross many jurisdictions during the course of movement, requiring the obtainment of multiple travel permits in order to complete a trip. Despite slight differences in permitting rules, regulations and fees, there typically exists a substantially similar jurisdictional procedure for permitting such vehicles in each jurisdiction.

At present, these jurisdictions operate independently and are limited in their ability to cooperate in this process, principally due to either a lack of permit automation altogether, or a lack of a standardized approach to permit automation and vehicle routing.

This results in the present situation, wherein the fundamentally similar process of permitting a vehicle is repeated across numerous jurisdictions, thereby creating a considerable duplication of effort and resources, which causes a resulting loss of efficiency for both the jurisdictions and the permit customers, since identical and often elaborate vehicle registration and configuration information must be communicated to each jurisdiction in order to complete the process of permitting.

Moreover, due to varying levels of permit enforcement across jurisdictions, combined with the repetitive and time-consuming burden of obtaining multiple permits, some potential permit customers will choose to travel in certain jurisdictions without obtaining a permit, in violation of regulations.

This results in the potential for physically hazardous situations due to the configuration of the vehicle operating without respect to the route, as well as loss of permit revenue for the jurisdiction.

### SUMMARY

Aspects of the present invention are directed to an organizational method of storing individual route segments, and an associated plurality of connected route segments in a stored database.

Each route segment may be defined by at least one starting node and ending node identifier, and at least one vehicle criterion limit that can be used to determine which types of vehicles are allowed to traverse the route segment. For example, vehicle criterion limits may include, but are not limited to: Maximum vehicle height, maximum vehicle width, maximum vehicle length, maximum front and/or rear overhang of the vehicle, maximum gross weight, and/or axle and/or axle group weight(s) allowable along the route segment.

Each route segment may also contain distance information as well as standard, allowable physical limits for non-permitted vehicle operation, such as a legal weight limits.

Each route segment and/or node may also contain one or more descriptive attributes such as, but are not limited to: Jurisdiction identifier, roadway number(s), roadway type(s), roadway direction, speed limit(s), toll road indicator/cost, congestion indicator, street address/address block, zip code, latitude/longitude, linear reference system identifiers, signage such as exit numbers or mile markers, intermodal connector identification (ID) information, the name of a municipality or city, or an industry name and/or location.

Further, each route segment may also contain administrative information such as an indicator that the segment is traversable, and temporary or permanent restrictions of the physical limits of the route segment, allowed vehicle configuration and/or load type, effective dates and/or times for these restrictions, and/or advisories and/or remarks concerning aspects of the segment and/or the restriction.

Using the standardized positioning information contained in each node, individual route segments may also be referenced as a unique collection of segments which contain descriptive attributes associated with the collection, such as, but not limited to: Total distance, general restrictions, user entity restrictions, vehicle and/or load type, and/or advisories or remarks regarding the underlying collection of segments.

Finally, using a unique identifier, each collection of individual segments can then be referenced by starting and ending node attributes as being a potentially-traversable origin and destination pair, depending on physical vehicle criteria, dates and times of travel, or other factors.

One or a plurality of these collections of route segments may exist for any distinct origin and destination pair.

This plurality of segment collections may be organized as discrete, complete routes by criteria such as total authorization cost, distance, frequency of use and/or travel time, and may be displayed one a computer screen during the route selection process while applying for a permit.

Jurisdiction authorities may choose to allow individual route segments, segment collections and/or complete routes be presented to permit customers during the permit routing process, thus for instance allowing routing only from discrete, pre-approved segments, collections of segments, or complete routes within their jurisdiction.

Jurisdiction authorities may further restrict availability of route segment(s), segment collection(s), and/or complete route(s), such as by highway number, permit customer and/or vehicle or vehicle load type, date, geographic boundaries, and/or other criteria.

Further, although an exhaustive and complete network of route segments, segment collections and complete routes may be defined, such an exhaustive and complete network is not necessary for each jurisdiction to independently or collaboratively implement routing practices using this method, and the quantity of traversable route segments may vary from jurisdiction to jurisdiction.

However, a partially or even entirely complete network of inactive, non-traversable segments may also exist within a jurisdiction with only certain segments, collections of segments, or complete routes being active and potentially-traversable.

Further, additional segments can be included, and indicated to be potentially traversable on an as-needed basis.

Route segment creation, the indication of segment availability and/or editing of descriptive segment data and/or physical criteria, as well as suspension of segment availability may be accomplished in a distributed fashion whereby each jurisdiction retains control over the limits and availability of each route segment within their jurisdiction.

Segment collection maintenance, such as editing of limits and descriptive collection data as well as suspension of collection availability may also be achieved in a distributed fashion whereby each jurisdiction may retain control over the limits and availability of each route segment, and/or each segment collection and/or complete route within their jurisdiction.

Route segments that cross, or terminate at jurisdictional boundaries may be connected via standardized node positioning identifiers at these boundaries to potentially enable routing across boundaries.

In a non-limiting example, during the permitting process a permit customer may be presented with either a graphical map, or a cascading list of origin and destination options, such as: From State, From City, To State, and To City with a list of available routes or highlighted map information from which to choose the preferred route.

### BRIEF DESCRIPTION OF THE DRAWINGS

The foregoing Summary, as well as the following Detailed Description of Illustrative Embodiments, is better understood when read in conjunction with the accompanying drawings, which are included by way of example, and not by way of limitation with regard to the claimed invention.

FIG. 1 is a functional block diagram of an illustrative vehicle routing and permitting system, in accordance with at least one aspect of the present invention.

FIG. 2 is a flow diagram showing illustrative steps that may be performed when a user interacts with the vehicle routing and permitting system of FIG. 1, in accordance with at least one aspect of the present invention.

FIG. 2A is a flow diagram showing illustrative steps that may be performed for providing routing and fee calculation to user entities based on route and physical vehicle criteria in accordance with at least one aspect of the present invention.

FIG. 3 is a functional block diagram of an illustrative routing server and database system in accordance with at least one aspect of the present invention.

FIG. 4 is an illustrative map detailing several routes between an origin and a destination with varying restrictions and distances, in accordance with at least one aspect of the present invention.

FIGS. 5-12A are illustrative screen shots for a user interface, in accordance with at least one aspect of the present invention.

FIG. 13 is a flow diagram showing illustrative steps that may be performed when a jurisdiction and/or service entity interacts with the vehicle routing and permitting system of FIG. 1, in accordance with at least one aspect of the present invention.

FIGS. 14-25C are illustrative screen shots for jurisdiction and/or service entity interfaces, in accordance with at least one aspect of the present invention.

### DETAILED DESCRIPTION OF ILLUSTRATIVE EMBODIMENTS

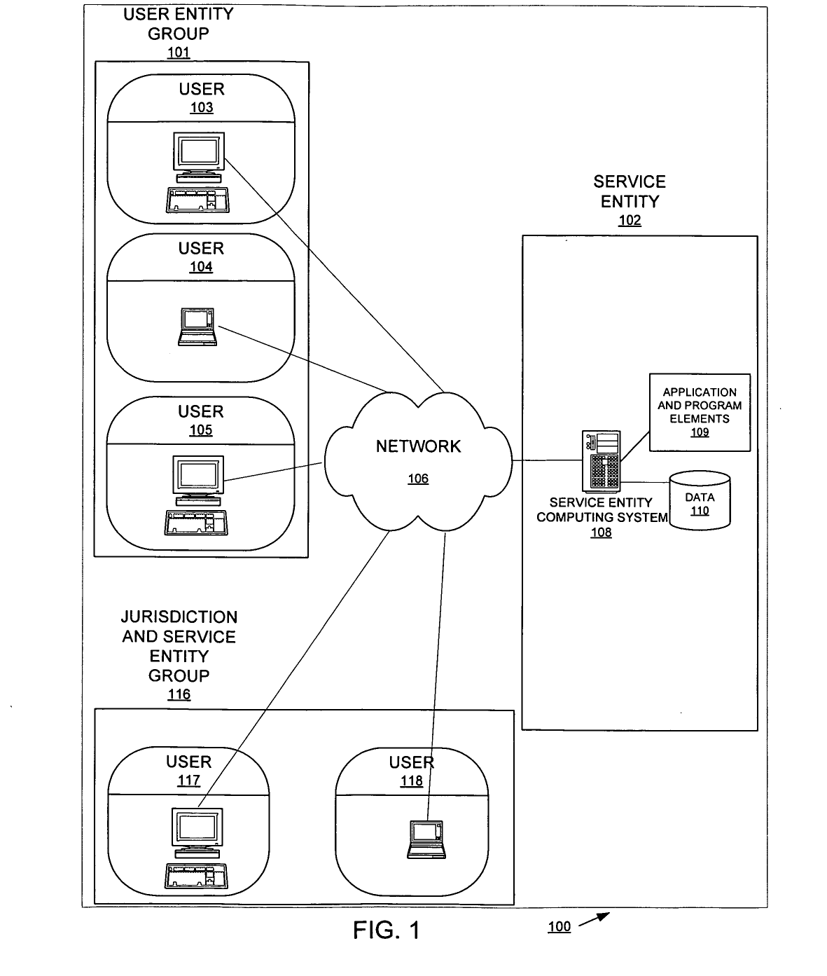

Referring to FIG. 1, an illustrative embodiment of a vehicle routing and permitting system 100 is shown. The system 100 ultimately provides for credential verification and direct purchase of a travel certificate validating the travel of a vehicle, also known as a permit. The term “vehicle” as used herein is broadly construed to include any type of vehicle such as a commercial truck, as well as a private passenger car or truck. As shown, the system 100 includes a user entity group 101 and a service entity 102. For the purposes of this disclosure, the term “service entity” should be broadly construed to include any type of private or public service provider, such as but not limited to a commercial service provider or an officially authorized state or other government agency. The user entity group 101 includes one or more user entity computing units 103, 104 and 105. A service entity 102 includes one or more service entity computing system(s) 108. The service entity computing system 108 and the user entity computing units 103-105 are inter-coupled through a network 106.

In this example, the system 100 further includes a jurisdiction and service entity group 116 that includes one or more jurisdiction and service entity computing units 117, 118. Jurisdiction and service entity group 116 may contain authorized employees or representatives of one or more jurisdictions who are typically charged with the administration of vehicle regulations within their jurisdiction. As will be described further on in the specification, each jurisdiction will typically maintain data 100 associated with the jurisdiction. There may also exist jurisdiction or service entity user(s) that maintain certain data 100 that can span a plurality of jurisdictions. As used herein, the term “jurisdiction” includes, but it not limited to, states, counties, cities, towns, countries, parishes, governmentally defined regions.

The network 106 may be any data communication network, such as but not limited to a private network, a public network, a local area network (LAN), a wide area network (WAN), a virtual private network (VPN), an intranet, a wired and/or wireless network, a landline or wireless telephone network, and/or the Internet.

The computing units 103-105, 117, and/or 118 may be any type of computing and/or communication devices, such as but not limited to personal computers, laptops, notebook computers, hand-held computers such as personal digital assistants (PDAs), television set top boxes, and/or cellular telephones. The computing units 103-105, 117, and/or 118 may be inter-coupled with one another over an additional network (such as an intranet) separate from the network 106, or they may be stand-alone computing units coupled only to the network 106. The coupling of the computing units 103-105, 117, and/or 118 may be a permanent connection (e.g., an “always-on” cable modem connection or direct Internet backbone connection) through a server at the premises of the user entity group 101 or only on an as-needed basis (e.g., using a dial-up telephonic modem connection). It will be readily appreciated that the user entity group 101 may include less or more than three computing units, and indeed may have only a single user entity computing unit. In addition, the user entity group 101 may include, but is not limited to multiple related users at the same location or many locations (e.g., a corporate grouping of employees), or multiple unrelated users at one or more locations. The same holds true for the jurisdiction and service entity group 116.

The service entity computing system 108 may further include a routing software application, contained in the application and program elements 109 (e.g., executed by the service entity computing system 108) and/or a storage device 110 that may include data 110. The service entity computing system 108 may further execute software that facilitates and/or implements communications and transactions between the user entity group 101, the jurisdiction and service entity group 116, and/or the service entity 102.

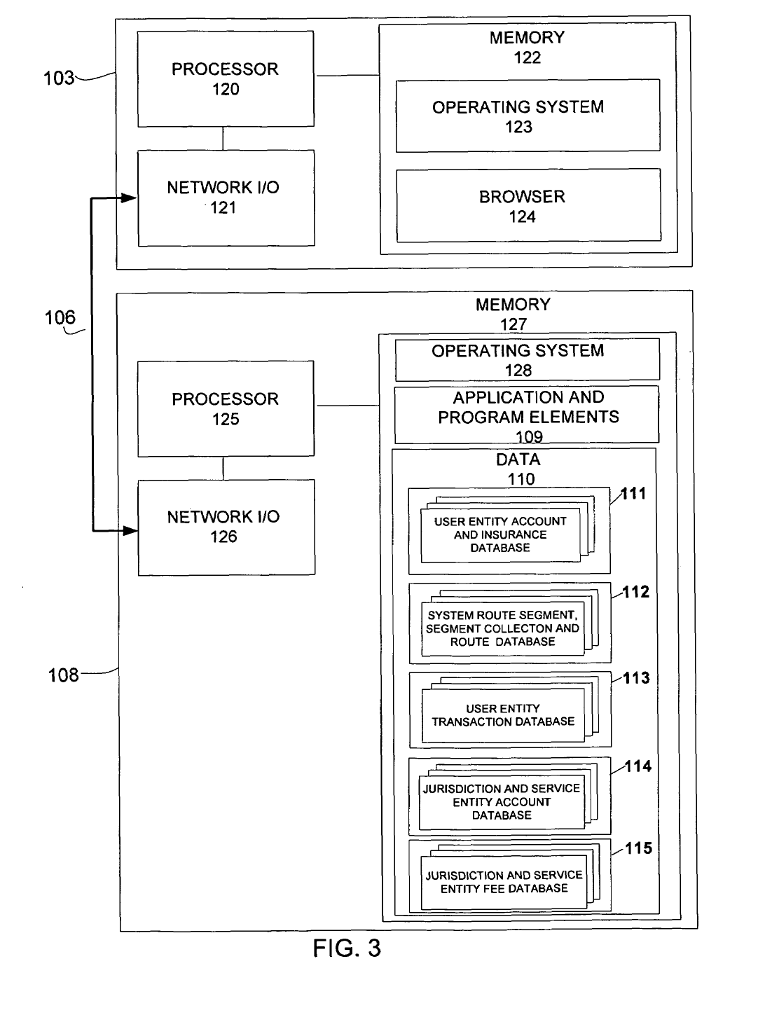

FIG. 3 depicts an illustrative functional block diagram showing the coupling of the user entity computing unit 103 and the service entity computing system 108 via the network 106. The structure and functionality of user entity units 104 and 105 may be identical to that of user entity computing unit 103 and as such will not be further described herein. As shown, user entity computing unit 103 has a processor 120, a memory 122, and a network input/output (I/O) interface 121 for accessing the network 106. The network I/O interface 121 may be implemented, for example, as a dial-up modem or as a permanent network connection. The processor 120, which may be a central processing unit (CPU) or any other processor, may be adapted to execute computer-executable software program instructions stored in a memory 122 or other one or more computer-readable storage media. For example, the user entity computing unit 103 may execute an operating system 123 that supports multiple applications. The operating system 123 may be any type of operating system, such as but not limited to a multitasking operating system that allows simultaneous execution of multiple applications in a graphical windowing environment. The memory 122 may further store a browser application program 124 (such as a conventional Internet browser application, e.g., Microsoft INTERNET EXPLORER brand browser) that is executable by the processor 120. As will be discussed further, information provided by the system 100, such as a series of routes between an origin and a destination, may be displayed onto a display device using the browser 124. The user entity computing unit 103 may further include e-mail software components (not shown) as well as additional hardware and software components and modules as desired.

The service entity computing system 108 includes one or more computer servers and one or more computing apparatuses, and may be considered to be a server system. The service entity computing system 108 as shown includes the application and program elements 109 enabling the service entity 108 to manage a user interface that is provided to the user entity computing unit 103 (and/or any other of the user entity computing units), such that the user at the user entity computing unit 103 can obtain a certificate from a certain vehicle routing and permitting service over the network 106.

FIG. 3 also contains a block diagram depicting a schematic diagram of the service entity computing system 108. As depicted, the service entity computing system 108 comprises a processor 125, such as a CPU, a memory 127 and a network I/O 126 (input/output) for connection to the network 106 (shown in FIG. 1). The network I/O 126 is preferably implemented as a permanent network connection, although dial up, or other forms of low-bandwidth connections may be suitable in certain embodiments. For example, if the service entity computing system 108 interacts with the user entity computing units 103, 104 and 105 via e-mail, then a dial-up or wireless connection may be suitable.

Like the user entity computing unit 103, the service entity computing system 108 may have a permanent or non-permanent network connection to the network 106. For purposes of discussion only, a permanent connection will be assumed as an example. The service entity computing system 108 may have a processor 125 configured to execute computer-executable software program instructions illustrated in application and program elements 109, in addition to a software operating system 128 stored in a memory 127 (or other one or more computer-readable storage media) for performing various functions. The memory 127 may store a data portion 110 including a user entity account and insurance database 111, a system route segment, segment collection and route database 112, a user entity transaction database 113, a jurisdiction and service entity account database 114, and/or a jurisdiction and service entity fee database 115. It will be readily appreciated that the service entity computing system 108 may include additional hardware and software components, databases, and modules as desired.

The user entity account and insurance database 111 may include one or more data elements associated with and representing users in the user entity group 101. Some non-limiting examples of data elements in the user entity account and insurance database 111 include a user entity identifier, a password, a user entity address, user entity account information, user entity insurance information, and/or user entity type defining whether the user entity is a direct user entity or a third party user entity, and/or primary business function type. It is within the scope of the invention for the user entity account and insurance database 111 to include information regarding vehicles (e.g., trucks) belonging to specific user entities as well as specific types of loads transported by the vehicles. As will be described further herein, the user entity account and insurance database 111 may be accessed by the service entity computing system 108 in response to a user entity logging on to the service entity computing system 108, such as via a website controlled by or otherwise associated with the service entity computing system 108, or responsive to specific user entity profile information being needed. An illustrative content and structure of the user entity account and insurance database 111 is shown below in Table 1.

TABLE 1

| | USDOT | | | | | | | Entity |
|---|---|---|---|---|---|---|---|---|
| | Number | | | | | User | | Primary |
| User | and | | User | User | User | Entity | | Business |
| Entity | Insurance | | Entity | Entity | Entity | Payment | Contact | Function |
| Identifier | Identifier | Password | Address | Insurance | Type | Method | Information | Type |
| User | 1234567 | test123 | 123 A | RST | Direct | Credit | abc@A.com | Mobile |
| Entity 1 | | | Street | Insurance | User | Card | | Home |
| | | | | Co | | | | Transport |
| User | 7654321 | password | 456 B | UVW | Third | Monthly | def@B.com | Various |
| Entity 2 | | | Street | Insurance | Party | Billing | | |
| | | | | Co. | User | | | |
| User | 3456765 | 12345 | 789 C | XYZ | Direct | Electronic | ghi@C.com | Construction |
| Entity 3 | | | Street | Insurance | User | Debit | | Equipment |
| | | | | Co. | | | | Transport |

A system route segment, segment collection, and route database 112 may also be stored that includes data elements associated with complete routes from an origin to a destination, segment collections, and/or individual route segments and/or nodes. Data regarding each route segment may be stored in segment collection(s) and/or complete route(s) that are also described by respective, standardized, beginning and ending point identifiers, descriptive information regarding the segment collection and/or complete route, such as roadway name, direction and/or interchange with other segments, the spanned distance of the route segments in the segment collection and/or route with the load, travel date and time restrictions and/or vehicle criteria limits associated with each of the individual segment(s), segment collection(s) and/or complete route(s). A route segment may define the properties of a section of roadway, while a segment collection or route may define an ordered series of segments and potentially the properties of that collection that combined extend from an origin to a destination. In a non-limiting example, within the database 112, there may exist a route segment table, a segment collection table and a complete route table. If a single segment and/or a contiguous sequence of route segments in the route segment table is indicated to be potentially includable in a segment collection, then the associated unique segment identifier(s) can be stored in the segment collection table whereby a unique segment collection identifier can be associated with the segment identifier(s) that refer to a single segment and/or a contiguous sequence of segments. Further, if a segment collection is indicated to be potentially includable in a complete route, then the segment collection identifier can be stored in the complete route table whereby a certain origin, possibly indicated by the first route segment in the segment collection, and a certain destination, possibly indicated by the last route segment in the segment collection can be associated with the unique segment collection identifier, thus enabling aggregation of the segment(s) and/or segment collection(s) data to be processed and displayed as complete routes. For example, a route between City A and City B may be a single highway, or may be Highway A, then Highway B, then Highway C, in that order. This example may be partly or wholly described as an individual segment, and/or a collection of contiguous segment(s) and/or a complete route. This system route segment, segment collection, and route database 112 may be pre-populated and/or modified to later include a plurality of route segments, collections of route segments and/or complete routes. Of course, any given location may be considered an origin or a destination, depending upon whether a given, traversable route is directed into the location or emanates from the location.

Examples of vehicle criteria limits for a given route segment and/or segment collection and/or route are maximum allowable vehicle weight (e.g., gross weight, single-axle weight, and/or axle group weight), maximum allowable vehicle size (e.g., height, width, and/or length), maximum allowable overhang (e.g., front overhang and/or rear overhang), and minimum axle spacing, as required by law or other requirement in order to traverse the given route. In general a vehicle criterion limit is a maximum, minimum, or allowable range of a physical characteristic of a vehicle. Each route segment and/or segment collection and/or route may further include information indicating the number of bridges traversed, the distance of low weight route segments, and/or the distance of high weight route segments, for each route segment and/or segment collection and/or route. Still further information that may be included in the database 112 pertains to route availability information that can serve to indicate whether the route may be traversed by all users, a limited group of users or type of user, or to allow the temporary or permanent suspension of travel on the route. Comments and advisories concerning user entity usage and jurisdiction entity maintenance of the segment comments regarding the route segment and/or segment collection and/or complete route may also be stored in the database 112.

User interfaces may be provided for maintenance of the system route segment, segment collection and route database 112 through the service entity computing system 108 and the application and program elements 109. These interfaces may be restricted to access by trusted users within a jurisdiction, or across multiple jurisdictions, such as service entity employees or contractors, and may provide for the maintenance of various aspects of the records specific to the jurisdiction, depending on trusted user permissions, both individually and in aggregate within the system route segment, segment collection and route database 112. Maintenance functions may, e.g., include addition and activation of individual route segment(s) segment collection(s) and/or complete route(s), the input and editing of vehicle criterion limits information, and/or changes to route segment and segment collection vehicle criterion limits, including flagging route segments or segment collections to temporary or permanent inactive status by route descriptive information and/or location criteria and/or date(s) and time(s). Service and/or jurisdiction entity comments regarding the route may also be stored in the system route segment, segment collection and route database 112. An interface may further be provided for the maintenance of the user entity account and insurance database 111 through the service entity computing system 108 and the application and program elements 109. This interface may similarly be restricted to access by trusted jurisdiction and/or service entity users, and provides for the maintenance of user account information. Maintenance functions may include, e.g., addition of user accounts, temporary or permanent suspension of user accounts, and user account modifications such as password reset.

In a non-limiting example, Tables 2A, 2B, 2C, 2D, 2E, 2F and 2G show illustrative components of a short embodiment of the route segment, segment collection and route database 112 containing route segments (Tables 2A, 2B, 2C, 2D, 2E), segment collections (Table 2F) and complete route information (Table 2G), associated by segment and/or segment collection and/or route identifier(s), traversing a plurality of states, and involving a plurality of origins and destinations. These tables 2A-2G are merely illustrative and may be further subdivided into additional tables and/or some of the tables may be merged with others of the tables.

The origins and destinations are described in this example as states, cities and/or specific locations within or adjacent to a city, roadway junction, or significant landmark (e.g., an industrial area) illustrated by commonly recognized descriptive information (e.g., Birmingham, Ala. at the I-20E/I-59N/US-11 junction) or Global Positioning System (GPS) coordinates, however the origins and destinations may be defined in other ways, such as but not limited to linear referencing system coordinates, landmarks, and other forms of geospatial and non-geospatial location identification information. Moreover, route segment(s), segment collection(s) and route(s) may be limited to a single jurisdiction (e.g., a as through multiple jurisdictions (e.g., etc.).

TABLE 2A

| | | | Starting | Starting |
|---|---|---|---|---|
| | Segment | | Location | Location |
| Jurisdiction | Identifier | Starting Location and/or Node | Latitude | Longitude |
| MS | MSAL001 | Jackson @ I-55 Interchange | 32.26655 | −90.12978 |
| AL | ALAL001 | Alabama @ State Line (from | 32.44881 | −88.40439 |
| | | Mississippi) | | |
| AL | ALMS001 | Birmingham @ I-20 W/I-59 S/US-11 | 33.34059 | −87.02982 |
| MS | MSLA001 | Jackson @ I-20 Interchange | 32.26171 | −90.20966 |
| LA | LALA001 | Louisiana @ State Line (from | 31.01117 | −90.50364 |
| | | Mississippi) | | |
| LA | LALA002 | Hammond @ I-12W | 30.48233 | −90.49168 |
| LA | LALA003 | Baton Rouge @ I-10 E | 30.41762 | −91.08963 |
| LA | LAMS001 | Hammond @ I-55N | 30.48233 | −90.49168 |
| MS | MSMS002 | Mississippi @ State Line (from | 31.01117 | −90.50364 |
| | | Louisiana) | | |
| MS | MSMS001 | Mississippi @ State Line (from | 32.44881 | −88.40439 |
| | | Alabama) | | |
| LA | LALA004 | Hammond @ I-55N | 30.48233 | −90.49168 |
| LA | LAMS002 | Slidell @ I-59N | 30.30849 | −89.74873 |
| MS | MSMS003 | Mississippi @ State Line (from | 30.45954 | −89.69794 |
| | | Louisiana) | | |
| MS | MSMS004 | Hattiesburg @ I-59N/US 49N | 31.36609 | −89.35485 |
| MS | MSMS005 | Jackson @ US 49S/I-20 | 32.26019 | −90.16072 |
| | | Interchange | | |
| MS | MSLA006 | Hattiesburg @ I-59S/US 49S | 31.36609 | −89.35485 |
| LA | LALA005 | Louisiana @ State Line (from | 30.45954 | −89.69794 |
| | | Mississippi) | | |
| LA | LALA006 | Slidell @ I-12W | 30.30849 | −89.74873 |

TABLE 2B

| | Additional | | | |
|---|---|---|---|---|
| | Starting | | Ending | Ending |
| Segment | Location | | Location | Location |
| Identifier | Identifier | Ending Location and/or Node | Latitude | Longitude |
| MSAL001 | 000010 | Mississippi @ State Line (to Alabama) | 32.44881 | −88.40439 |
| ALAL001 | 000011 | Birmingham @ I-20 E/I-59 N/US-11 | 33.34059 | −87.02982 |
| ALMS001 | 000012 | Mississippi @ State Line (from | 32.44881 | −88.40439 |
| | | Alabama) | | |
| MSLA001 | 000014 | Mississippi @ State Line (to Louisiana) | 31.01117 | −90.50364 |
| LALA001 | 000015 | Hammond @ I-12W | 30.48233 | −90.49168 |
| LALA002 | 000016 | Baton Rouge @ I-10W | 30.41762 | −91.08963 |
| LALA003 | 000017 | Hammond @ I-12E | 30.48233 | −90.49168 |
| LAMS001 | 000017 | Louisiana @ State Line (to Mississippi) | 31.01117 | −90.49168 |
| MSMS002 | 000018 | Jackson @ I-20 Interchange | 32.26171 | −90.20966 |
| MSMS001 | 000013 | Jackson @ I-55 Interchange | 32.26655 | −90.12978 |
| LALA004 | 000017 | Slidell @ I-59N | 30.30849 | −89.74873 |
| LAMS002 | 000019 | Mississippi @ State Line (from | 30.45954 | −89.69794 |
| | | Louisiana) | | |
| MSMS003 | 000020 | Hattiesburg @ I-59N/US49N | 31.36609 | −89.35485 |
| MSMS004 | 000021 | Jackson @ US49N/I-20 Interchange | 32.26019 | −90.16072 |
| MSMS005 | 000023 | Hattiesburg @ I-59S/US 49S | 31.36609 | −89.35485 |
| MSLA006 | 000024 | Mississippi @ State Line (to Louisiana) | 30.45954 | −89.69794 |
| LALA005 | 000025 | Slidell @ I-12W | 30.30849 | −89.74873 |
| LALA006 | 000026 | Hammond @ I-55N | 30.48233 | −90.49168 |

TABLE 2C

| | Additional | | | | Activation | Segment |
|---|---|---|---|---|---|---|
| | Ending | | | Modified by | and/or | Inactivation |
| Segment | Location | | | Jurisdiction | Modification | Date(s) |
| Identifier | Identifier | Segment Description | Miles | Entity | Date | Time(s) |
| MSAL001 | 000011 | I-20E | 108.1 | jsmith | 15-Jun-08 | 06-15-2008 |
| | | | | | | 12:00 PM CST |
| | | | | | | to 06-30-2008 |
| | | | | | | 2:00 PM CST |
| ALAL001 | 000012 | I-20E TO I-20 E/I-59 | 113.2 | rchambers | 15-Jun-08 | |
| | | N/US-11 | | | | |
| ALMS001 | 000013 | I-20W | 124.2 | bhopewell | 15-Jun-08 | |
| MSLA001 | 000015 | I-55S | 128.0 | jsmith | 15-Jun-08 | |
| LALA001 | 000016 | I-55S | 36.0 | dsykes | 15-Jun-08 | |
| LALA002 | 000017 | I-12W | 40.0 | dsykes | 15-Jun-08 | |
| LALA003 | 000016 | I-12E | 40.0 | dsykes | 15-Jun-08 | |
| LAMS001 | 000018 | I-55N | 36.0 | dsykes | 15-Jun-08 | |
| MSMS002 | 000014 | I-55N | 128.0 | jsmith | 15-Jun-08 | |
| MSMS001 | 000010 | I-20W | 107.0 | jsmith | 15-Jun-08 | |
| LALA004 | 000019 | I-12E | 47.0 | dsykes | 15-Jun-08 | |
| LAMS002 | 000020 | I-59N | 11.0 | dsykes | 15-Jun-08 | |
| MSMS003 | 000021 | I-59N | 67.0 | jsmith | 15-Jun-08 | |
| MSMS004 | 000022 | 49N | 82.0 | jsmith | 15-Jun-08 | |
| MSMS005 | 000024 | 49S | 82.0 | jsmith | 15-Jun-08 | |
| MSLA006 | 000025 | I-59S | 67.0 | jsmith | 15-Jun-08 | |
| LALA005 | 000026 | I-59S | 11.0 | dsykes | 15-Jun-08 | |
| LALA006 | 000027 | I-12W | 47.0 | dsykes | 15-Jun-08 | |

TABLE 2D

| | | Maximum | Legal | | Maximum | Segment |
|---|---|---|---|---|---|---|
| Segment | Segment | Gross | Gross | Maximum | Axle | Active and |
| Identifier | Direction | Weight | Capacity | Axle Weight | Capacity | Traversable? |
| MSAL001 | E | 160000 | 80000 | 40000 | 34000 | NO |
| ALAL001 | E | 150000 | 80000 | 40000 | 34000 | YES |
| ALMS001 | W | 150000 | 80000 | 40000 | 34000 | YES |
| MSLA001 | S | 170000 | 80000 | 40000 | 34000 | YES |
| LALA001 | S | 170000 | 80000 | 34000 | 34000 | YES |
| LALA002 | W | 155000 | 80000 | 40000 | 34000 | YES |
| LALA003 | E | 160000 | 80000 | 40000 | 34000 | YES |
| LAMS001 | N | 164000 | 80000 | 40000 | 34000 | YES |
| MSMS002 | N | 180000 | 80000 | 40000 | 34000 | YES |
| MSMS001 | W | 170000 | 80000 | 40000 | 34000 | YES |
| LALA004 | E | 160000 | 80000 | 40000 | 34000 | YES |
| LAMS002 | N | 160000 | 80000 | 40000 | 34000 | YES |
| MSMS003 | N | 165000 | 80000 | 40000 | 34000 | YES |
| MSMS004 | N | 150000 | 80000 | 40000 | 34000 | YES |
| MSMS005 | S | 150000 | 80000 | 40000 | 34000 | YES |
| MSLA006 | S | 140000 | 80000 | 40000 | 34000 | YES |
| LALA005 | S | 165000 | 80000 | 40000 | 34000 | YES |
| LALA006 | W | 170000 | 80000 | 40000 | 34000 | YES |

TABLE 2E

| | Maximum | Maximum | Maximum | Maximum | Maximum | Maximum | |
|---|---|---|---|---|---|---|---|
| Segment | Height | Height | Width | Width | Length | Length | Segment |
| Identifier | (Feet) | (Inches) | (Feet) | (Inches) | (Feet) | (Inches) | Comments |
| MSAL001 | 16 | 1 | 14 | 1 | 120 | 4 | Temporarily |
| | | | | | | | Suspended |
| | | | | | | | (construction) |
| ALAL001 | 15 | 2 | 14 | 2 | 120 | 3 | |
| ALMS001 | 15 | 2 | 14 | 3 | 120 | 2 | |
| MSLA001 | 15 | 5 | 14 | 6 | 120 | 0 | |
| LALA001 | 17 | 3 | 13 | 3 | 120 | 0 | |
| LALA002 | 16 | 2 | 14 | 1 | 115 | 0 | |
| LALA003 | 16 | 1 | 14 | 0 | 120 | 0 | |
| LAMS001 | 16 | 2 | 14 | 0 | 120 | 0 | |
| MSMS002 | 16 | 0 | 14 | 0 | 120 | 0 | |
| MSMS001 | 17 | 0 | 15 | 0 | 120 | 0 | |
| LALA004 | 16 | 0 | 15 | 0 | 120 | 0 | |
| LAMS002 | 16 | 1 | 15 | 0 | 120 | 0 | |
| MSMS003 | 17 | 2 | 14 | 0 | 120 | 0 | |
| MSMS004 | 15 | 9 | 12 | 3 | 120 | 0 | |
| MSMS005 | 15 | 3 | 12 | 2 | 120 | 0 | |
| MSLA006 | 16 | 1 | 13 | 1 | 120 | 0 | |
| LALA005 | 17 | 1 | 13 | 6 | 120 | 0 | |
| LALA006 | 16 | 2 | 14 | 5 | 120 | 2 | |

TABLE 2F

| Route | | | |
|---|---|---|---|
| Segment | Route | | |
| Collection | Segments | Traversal | |
| Identifier | Included | Sequence | Notes: |
| 0000001 | MSAL001 | 1 | |
| 0000001 | ALAL001 | 2 | |
| 0000002 | MSLA001 | 1 | |
| 0000002 | LALA001 | 2 | |
| 0000003 | ALMS001 | 1 | |
| 0000003 | MSMS001 | 2 | |
| 0000004 | LALA003 | 1 | |
| 0000004 | LAMS001 | 2 | |
| 0000002 | LALA002 | 3 | |
| 0000004 | MSMS002 | 3 | |
| 0000006 | LALA003 | 1 | |
| 0000006 | LALA004 | 2 | |
| 0000006 | LAMS002 | 3 | Pavement Damage Speed |
| | | | Restricted to 55 MPH |
| 0000006 | MSMS003 | 4 | Pavement Damage Speed |
| | | | Restricted to 55 MPH |
| 0000006 | MSMS004 | 5 | |
| 0000005 | MSMS005 | 1 | |
| 0000005 | MSLA006 | 2 | |
| 0000005 | LALA005 | 3 | |
| 0000005 | LALA006 | 4 | |
| 0000005 | LALA002 | 5 | |

TABLE 2G

| | | | | Route | |
|---|---|---|---|---|---|
| | | | | Segment | Route |
| Origin | | Destination | Destination | Collection | Travers- |
| State | Origin City | State | City | Identifier | able? |
| MS | Jackson | AL | Birmingham | 0000001 | NO |
| MS | Jackson | LA | Baton | 0000002 | YES |
| | | | Rouge | | |
| AL | Birmingham | MS | Jackson | 0000003 | YES |
| LA | Baton Rouge | MS | Jackson | 0000004 | YES |
| MS | Jackson | LA | Baton | 0000005 | YES |
| | | | Rouge | | |
| LA | Baton Rouge | MS | Jackson | 0000006 | YES |

In a non-limiting example, within the database 112, there may exist a route segment table (1A, 2B, 2C, 2D, 2E), a segment collection table (2F) and a complete route table (2G). If a single segment and/or a contiguous sequence of route segments in the route segment table is indicated to be potentially includable in a segment collection, then the associated unique segment identifier(s) can be stored in the segment collection table whereby a unique segment collection identifier can be associated with the segment identifier(s) that refer to a single segment and/or a contiguous sequence of segments. Further, if a segment collection is indicated to be potentially includable in a complete route, then the segment collection identifier can be stored in the complete route table whereby a certain origin, possibly indicated by the first route segment in the segment collection, and a certain destination, possibly indicated by the last route segment in the segment collection can be associated with the unique segment collection identifier, thus enabling aggregation of the segment(s) and/or segment collection(s) data to be processed and displayed as complete routes.

Further, a hierarchy of physical criteria as well as other data may also be stored, retrieved and processed in a unidirectional or bidirectional manner across the route segment, segment collection, and/or complete route tables, such as temporary criteria restriction(s), or an advisory that can be stored in the segment collection table and thus encompass a plurality of route segments. As an example, route segment MSLA001, described as starting location “Jackson @ I-20 Interchange” to ending location “Mississippi @ State Line (to Louisiana), with the segment being described as “I-55S” with a length of 128.0 miles, and route segment LALA001, described as starting location “Louisiana @ State Line (from Mississippi)” to ending location “Hammond I-12W” with the segment also being described as “I-55S” with a length of 36.0 miles, and route segment LALA002 described as starting location “Hammond I-12W” to ending location “Baton Rouge @ I-10W” with the segment being described as “I-12W” with a length of 40.0 miles are assembled by segment identifier as being contiguous and sequential segments in segment collection table 2F and having the route segment collection identifier 0000002, which is then referenced in route table 2G. The user-selected origin displayed during the routing process may appear in textual format as “MS” and “Jackson @ I-20 Interchange” or more simply “MS” and “Jackson” or the origin may potentially be displayed in graphical form, such as on a map with the corresponding textual labels.

In addition, the user-selected destination displayed during the routing process may appear in textual format as “LA” and “Baton Rouge @ I-10W” or more simply “LA” and “Baton Rouge”, or the destination may potentially be displayed in graphical form, such as on a map with corresponding textual labels. Finally, the route indicated as being user-selectable, provided the criteria in 2C, 2D and 2E encompass the user-input date(s) and times of travel(s), load type and physical vehicle criteria (as later defined in the specification) would appear in a textual form such as: “I-55S (128 miles) I-55S (36 miles) 1-12W (40 miles) 204 miles total” or the route may potentially be displayed in graphical form, such as on a map with corresponding textual labels.

As another example, route segment MSAL001, described as starting location “Jackson @ I-55 Interchange” to ending location “Mississippi @ State Line (to Alabama)” is indicated in the route segment table (2A-2E) as being non-traversable, therefore, any segment collection(s) (2F), such as the segment collection identified by Route Segment Collection Identifier 0000001 and/or complete routes(s) (2G) such as the route identified by Route Segment Collection Identifier 0000001 that include route segment MSAL001 would not be processed and displayed, or optionally would be processed and displayed as non-selectable.

It should be noted that portions, including but not limited to segment identifiers, route segment collection identifiers and traversal sequences of the segment collection and complete route tables can, as an automated or manual process be pre-populated from the active segments in the route segment table, or be populated on demand during the route selection process.

Jurisdiction and service entity account database 114 includes data elements associated with user entities within and/or across jurisdiction entity groups(s) as well as other types of service entities. Some non-limiting examples of data elements in the database 114 include: a jurisdiction entity identifier, a password, and user entity features which defines whether the jurisdiction entity user is granted permission to create and maintain other user accounts within the jurisdiction, add remarks to segment(s), and/or edit route segment criteria and/or inactivate route segment(s). Another non-limiting example is a jurisdiction and/or service entity user that has sufficient user permissions to maintain account and/or individual route segment(s), segment collection(s) and/or complete route(s) information across a plurality of jurisdictions. As will be described further on in the specification, the jurisdiction and service entity account database 114 may be accessed by the service entity computing system 108 when a jurisdiction and/or service entity user logs on to the service entity's website, or when specific jurisdiction and/or service entity profile information is needed. A non-limiting example of implementation of jurisdiction and service entity account database 114 is shown below in Tables 2H and 2I.

TABLE 2H

| | | | Allow Fee and | Create/Maintain |
|---|---|---|---|---|
| | | Administrator | Restriction | Additional |
| | Administrator | Login | Table | Jurisdiction |
| Jurisdiction Entity | Login Name | Password | Editing | Users |
| MS | jsmith | password | YES | YES |
| LA | dsykes | 123abc | YES | YES |
| AL | rchambers | Denmark | YES | YES |
| AL | bhopewell | calvern | NO | NO |
| SE Regional | jaustin | O12ABR! | YES | YES |
| Administrator | | | | |

TABLE 2I

| | | Allow | | Allow | | |
|---|---|---|---|---|---|---|
| | Admin | Segment | Allow | Segment | | |
| Jurisdiction | Login | Criteria | Segment | Collection | Allow | Contact |
| Entity | Name | Management | Inactivation | Management | Remarks | Information |
| MS | jsmith | YES | YES | YES | YES | jsmith@ms.gov |
| LA | dsykes | YES | YES | NO | YES | dyskes@la.gov |
| AL | rchambers | YES | YES | YES | YES | rchambers@al.gov |
| AL | bhopewell | NO | YES | NO | YES | bhopewell@al.gov |
| SE Regional | jaustin | NO | YES | YES | YES | jaustin@.reg.gov |
| Administrator | | | | | | |

Jurisdiction and service entity fee database 115 includes data elements associated to various fee and regulation structures of the jurisdiction entities. Some non-limiting examples of data elements in the database include: A jurisdiction and/or service entity identifier, and criteria related to size, weight (including, but not limited to gross weight and various configurations of axles and axles spacing(s), load type as needed to determine appropriate fees for any set of criteria within a jurisdiction or across a plurality of jurisdictions. As will be described further on in the specification, the jurisdiction and service entity fee database 115 may be accessed by the service entity computing system 108 when a jurisdiction and/or service entity logs on to the service entity's website, or when specific jurisdiction and/or service entity fee information is needed. A non-limiting example of implementation of jurisdiction and service entity fee database 115 is shown below in Tables 2J, 2K, 2L, 2M and 2N.

TABLE 2J

| | | | | | Gross |
|---|---|---|---|---|---|
| Jurisdiction | Minimum | Maximum | | Overweight | Overweight |
| Entity | Miles | Miles | Axles | Quantifier | Cost |
| MS | ANY | ANY | ANY | W_Cost = ($.05 * (gross_wt − | W_Cost |
| | | | | segment_maximum)/ | |
| | | | | 1000 Lbs * miles | |
| | | | | per each segment | |
| | | | | traversed) | |
| AL | ANY | ANY | ANY | >80,000 and <=100,000 Lbs. | $10.00 |
| AL | ANY | ANY | ANY | >100,000 and <=125,000 Lbs. | $30.00 |
| AL | ANY | ANY | ANY | >125,000 and <=150,000 Lbs | $60.00 |
| AL | ANY | ANY | ANY | >150,000 Lbs | $100.00 |
| LA | 0 | 50 | 3 | (Actual Weight − legal | $20.00 |
| | | | | Weight) <= 10000 Lbs | |
| LA | 51 | 100 | 3 | (Actual Weight − legal | $30.00 |
| | | | | Weight) > 10,000 | |
| | | | | and | |
| | | | | <=20,000 Lbs | |
| LA | 101 | 150 | 3 | (Actual Weight − legal | $35.00 |
| | | | | Weight) > 20,000 | |
| | | | | and | |
| | | | | <=30,000 Lbs | |

TABLE 2K

| | | | Jurisdiction | Jurisdition | |
|---|---|---|---|---|---|
| | Axle | | Overweight | Overweight | Tandem Axle |
| Jurisdiction | Overweight | Overweight | Limit | Limit U.S. | Limit |
| Entity | Cost | Load Type | Interstate | Highways | Interstate |
| MS | W_Cost | ALL | 160,000 | 150,000 | 40,000 |
| AL | 0.00 | ALL | N/A | N/A | 40,000 |
| AL | 0.00 | ALL | N/A | N/A | 40,000 |
| AL | 0.00 | ALL | N/A | N/A | 40,000 |
| AL | 0.00 | ALL | 160,000 | 155,000 | 40,000 |
| LA | $30.00 | ALL | N/A | N/A | 40,000 |
| LA | $30.00 | ALL | N/A | N/A | 40,000 |
| LA | $35.00 | ALL | N/A | N/A | 40,000 |

TABLE 2L

| | Tandem Axle Limit | Jurisdiction |
|---|---|---|
| Jurisdiction Entity | Highways | Overweight Restriction Notices |
| MS | 37,000 | Permit Holder Must Bypass |
| | | Posted Bridges |
| AL | 37,000 | None |
| AL | 37,000 | None |
| AL | 37,000 | None |
| AL | 37,000 | None |
| LA | 37,000 | None |
| LA | 37,000 | None |
| LA | 37,000 | None |

TABLE 2M

| Jurisdiction | | | | |
|---|---|---|---|---|
| Entity | Oversize Type | Min Height | Max Height | Min Length |
| MS | ANY | 13 Feet 6 | 16 Feet 0 | 70 Feet 0 |
| | | Inches | Inches | Inches |
| AL | Mobile Home | 13 Feet 6 | 15 Feet 0 | 0 Feet 0 |
| | | Inches | Inches | Inches |
| AL | Mobile Home | 0 Feet 0 | 15 Feet 0 | 0 Feet 0 |
| | | Inches | Inches | Inches |
| AL | Boat | 0 Feet 0 | 15 Feet 0 | 0 Feet 0 |
| | | Inches | Inches | Inches |
| AL | OTHER | 0 Feet 0 | 15 Feet 0 | 0 Feet 0 |
| | | Inches | Inches | Inches |
| LA | Mobile Home | 0 Feet 0 | 16 Feet 0 | 0 Feet 0 |
| | | Inches | Inches | Inches |
| LA | OTHER | 0 Feet 0 | 15 Feet 0 | 0 Feet 0 |
| | | Inches | Inches | Inches |
| LA | OTHER (with | 13 Feet 6 | 15 Feet 0 | 75 Feet 0 |
| | Overweight) | Inches | Inches | Inches |

TABLE 2N

| | | | | | Global |
|---|---|---|---|---|---|
| Jurisdiction | | | | Oversize | Overweight |
| Entity | Max Length | Min Width | Max Width | Cost | Restriction Notices |
| MS | 125 Feet 0 | 8 Feet 6 | 14 Feet 0 | $10.00 | Permit Holder Must |
| | Inches | Inches | Inches | | Use Front Escort |
| AL | 75 Feet 0 Inches | 8 Feet 6 | 12 Feet 0 | $10.00 | Permit Holder Must |
| | | Inches | Inches | | Use Rear Escort |
| AL | 115 Feet 0 | 12 Feet 0 | 14 Feet 0 | $20.00 | Permit Holder Must |
| | Inches | Inches | Inches | | Use Front and Rear |
| | | | | | Escort |
| AL | 75 Feet 0 Inches | 8 Feet 6 | 12 Feet 0 | $10.00 | Permit Holder Must |
| | | Inches | Inches | | Use Front Escort |
| AL | 115 Feet 0 | 12 Feet 0 | 14 Feet 0 | $20.00 | Permit Holder Must |
| | Inches | Inches | Inches | | Use Front Escort |
| LA | 115 Feet 0 | 8 Feet 6 | 14 Feet 0 | $10.00 | Permit Holder Must |
| | Inches | Inches | Inches | | Display Oversize |
| | | | | | Banner |
| LA | 115 Feet 0 | 8 Feet 6 | 14 Feet 0 | $15.00 | Permit Holder Must |
| | Inches | Inches | Inches | | Display Oversize |
| | | | | | Banner |
| LA | 115 Feet 0 | 8 Feet 6 | 14 Feet 0 | $25.00 | Permit Holder Must |
| | Inches | Inches | Inches | | Display Oversize |
| | | | | | Banner |

The service entity computing system 108 may further include a user entity transaction database 113 that may include aggregate transaction information that may associate a registered user identified in the user entity account and insurance database 111 with specific route(s) from the system route segment, segment collection, and route database 112, and the jurisdiction and service entity fee database 115. The information contained in the database 115 may further be processed against, and/or superimposed in a hierarchical manner upon the information limits contained in the database 112, thus allowing a broader application of physical vehicle criteria limits and fees by 115 within a jurisdiction, or across a plurality of jurisdictions. This information in the databases 111, 112, 115, or the processed results of calculation(s) or superimposition(s) may be stored in or referenced by elements of the user entity transaction database 113, and is shown by way of non-limiting example in Tables 3A, 3B and 3C. Additional information stored in the database 113 may include, but is not limited to, USDOT number, insurance information including coverage limits, insurance company policy number and insurance status, permit type, vehicle criteria, vehicle registration information such as tag, state of registration and/or vehicle identification information, load information, intended travel date(s) and time(s) and any related travel restrictions based on the permit type, and/or vehicle criteria for the vehicle associated with the respective user. Fees computed for user transaction(s) may also be stored in this database 113 for jurisdiction and/or service entity billing purposes.

TABLE 3A

| | | | | | | Vehicle | Vehicle | |
|---|---|---|---|---|---|---|---|---|
| | | | | | Vehicle | Single | Axle | Vehicle |
| | User | Permit | | | Gross | Axle | Group | Axle |
| Transaction | Entity | Recipient | Route | Permit | Weight | Weight | Weight | Spacing |
| Identifier | Identifier | Identifier | Identifier | Type | (lbs) | (lbs) | (lbs) | (Feet) |
| W90000 | User | User | 000002 | Legal Trip | 91000 | 33000 | 36000 | 7.0 |
| | Entity 1 | Entity 1 | | | | | | |
| W90001 | User | User | 000005 | Oversize | 80000 | 32000 | 37000 | 7.0 |
| | Entity 2 | Entity 1 | | | | | | |
| W90002 | User | User | 000004 | Oversize | 115000 | 33000 | 36000 | 8.0 |
| | Entity 3 | Entity 3 | | and | | | | |
| | | | | Overweight | | | | |

TABLE 3B

| | Vehicle | Vehicle | Vehicle | | Vehicle Rear |
|---|---|---|---|---|---|
| Transaction | Height | Width | Length | Vehicle Front | Overhang |
| Identifier | (feet) | (feet) | (feet) | Overhang (feet) | (feet) |
| W90000 | 13.0 | 8.0 | 55.0 | 0 | 0 |
| W90001 | 14.0 | 9.0 | 75.0 | 0 | 0 |
| W90002 | 13.9 | 8.9 | 74.5 | 0 | 0 |

TABLE 3C

| Transaction | Travel | Vehicle | Vehicle | Load | Oversize | Overweight | Legal | Total |
|---|---|---|---|---|---|---|---|---|
| Identifier | Date/Time | Make | Tag/VIN | Description | Fees | Fees | Fees | Fees |
| W90000 | 08/04/2004 | PB | ABC123 | Equipment | 0.00 | 0.00 | $25 | $25.00 |
| W90001 | 08/06/2004 | IH | DEF456 | Turbine | $10.00 | 0.00 | 0.00 | $10.00 |
| W90002 | 08/04/2004 | MK | GHI789 | Trusses | $10.00 | $197.50 | 0.00 | $207.50 |

An illustrative use of each of these databases 111, 112, 113, 114 and 115 will be described in greater detail later in the specification. It is to be expressly understood that other formats for each of the above noted databases are possible without detracting from the spirit of the invention. It should also be expressly understood that other units of measure and/or data fields including additional data elements and/or organization of data elements may be included and omitted without detracting from the spirit of the invention.

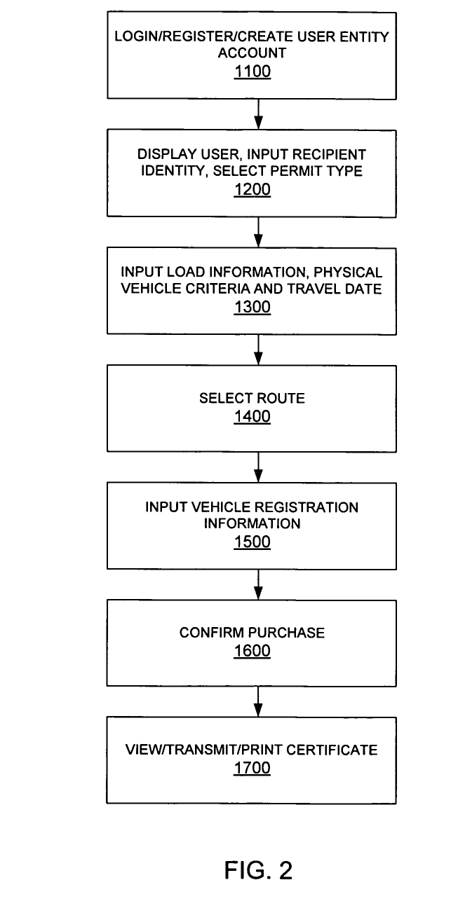

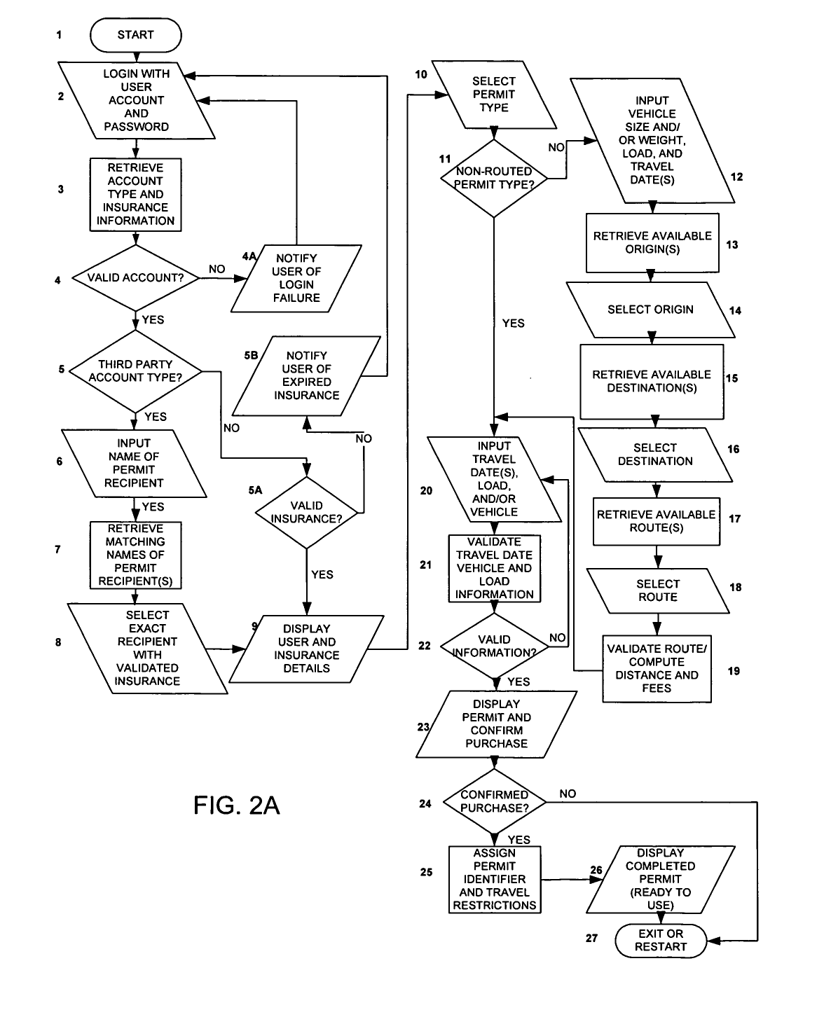

An illustrative interaction between the user entity group 101 and the service entity 102 is described in relation to the vehicle routing and permitting system 100 according to an example of implementation of the present invention. With reference to FIG. 2, at step 1100 a user at the user entity group 101 accesses a secure website (for example) of the service entity 102 by either entering a predetermined user identification and password, or by registering as a new user. Once the identity of the user has been verified by the service entity computing system 108, the user is granted access to the application and program elements 109 of the service entity 102. The user may preview the available routes in the system route segment, segment collection and route database 112 if desired before registering and/or logging in. The user may interact with the service entity computing system 108 via a user input device at the user entity computing unit 103, such as but not limited to a keyboard, a pointing device, a touch-sensitive pointing surface, a speech recognition unit.

At step 1200, the user is presented with a user interface on a display device of the user entity computing device 103. The user interface may be a graphical user interface or other type of user interface. For a “direct” type user classification, where the recipient and billing information describe the same user, the user interface may display the user's name, address, insurance information, and/or billing information. For a third-party user, where the recipient and billing entities are distinct and different, the user interface may present the user the opportunity to select the recipient entity. In any event, the user is then prompted to select a permit type. In a non-limiting example, permit types may include legal, oversize, overweight, oversize and overweight, mobile home oversize, and trip. A trip permit may be added to any of the above permit types. Other permit types may be added or substituted in accordance with the spirit of this invention.

At step 1300, the user interface, the presentation of which may vary based on permit type selected in step 1200, may allow the user to input vehicle criteria. For example, the user may input the type of load, travel dates and/or times, height, width, weight, rear overhang, front overhang, and/or axle information. In general, a vehicle criterion is a physical characteristic of the vehicle. This may be done by providing the user with a set of user-modifiable data fields. Once the above-described information is provided, the user entity submits this information to the service entity 102 via network 106. In response, the application and program elements 109 optionally searches the system route segment, segment collection and route database 112 for only those origin(s) that allow movement to occur based on the physical vehicle criteria entered in step 1300.

At step 1400, the user interface presents the user with a screen that, for example, contains a textual list and/or graphical map of route origins, which may, by default, be organized by jurisdiction and location within the jurisdiction. The origin(s) included in the displayed list and/or map may depend upon the load information, travel date and/or physical vehicle criteria entered by the user in step 1300, or optionally displayed as either all origins, or all origins with the non-traversable origins indicated to be non-selectable. From this screen, the user may select a preferred origin. In response, the application and program elements 109 optionally searches the system route segment, segment collection and route database 112 for only those destinations that are traversable from the origin based on the physical vehicle criteria entered in step 1300. The found subset of destinations, or optionally all destinations with the non-traversable destinations being indicated as non-selectable are then displayed as a list or map by the user interface. From this screen, the user entity may select a preferred one of the listed destination(s). In response, the application and program elements 109 searches the system route segment, segment collection and route database 112 for those routes that are traversable from the selected origin to the selected destination based on the type of load, travel date(s) and time(s) and/or physical vehicle criteria entered in step 1300. The user interface then displays to the user the found route(s) as a sequential list of contiguous and traversable route segment(s), extending from the origin to the destination, and organized as one complete set of segment(s) per line. It should be noted that if any of the route segments comprising a segment collection, or any collection(s) comprising a complete route are non-traversable based on the type of load, travel date(s) and time(s) and/or physical vehicle criteria, or the administrative inactivation of the route segment, segment collection or complete route, then that particular route, as a whole will not appear as an option in the list of routes, or alternatively may appear but be indicated as non-selectable. At this point, the user may select a preferred one of the listed route(s). In this non-limiting example, these origin(s), destination(s), and route(s) are displayed in a tabular list format, however these items may be displayed in any other format, and may be displayed graphically (e.g., in a map format) and/or include such information as nodes, lines, polylines, Global Positioning System (GPS) coordinates, or other types of waypoint coordinates or other identifiers.

At step 1500, the user interface confirms the user-selected origin, destination, route and accompanying fees for such travel. In this non-limiting example, the user may be required to input a vehicle make, vehicle registration, and description information for the vehicle for which a permit is being ultimately requested. Once the above-described information is provided, the user may confirm the purchase by submitting this information to the service entity 102 via network 106 (e.g., by selecting a displayed “submit” or “okay” button).

At step 1600, the user interface confirms the user's intent to purchase a permit. The permit may be assigned a unique transaction identifier and a retrievable and transmittable link, e.g., a universal resource locator (URL) link, to a permit confirmation certificate. At step 1700, the user retrieves the permit certificate by selecting the link provided in step 1600. This certificate, which can serve to provide confirmation of the transaction, and detailed information regarding the vehicle, route and any costs incurred may be viewed, printed, or transmitted to another user, or stored for later retrieval.

At this point, the transaction process may be considered to be complete, and the user may terminate the session, or repeat or modify the process to purchase another permit certificate. Each of the above mentioned steps will be described below with reference to various illustrative screen shots of the user interface.

### Login/Register/Create User Entity Account (Step 1100)

To access the vehicle routing and permitting system 100, the user may invoke the browser 124 and enter the service entity's 102 specific network address or domain name server (DNS) name. It should be expressly understood that the user might be a user of any of the user entity computing unit 103-105 within the user entity group 101 that accesses the vehicle routing and permitting system 100. The user at user entity computing unit 103 will be considered the user for purposes of this example. Also, it will be assumed for purposes of this example that the user accesses the service entity 102 via a web page using the browser 124. However, the user may access the service entity 102 in any of a number of ways. Responsive to the user selecting the service entity's 102 network address or DNS name, the browser 124 displays a web page on a display device of the user entity computing unit 103.

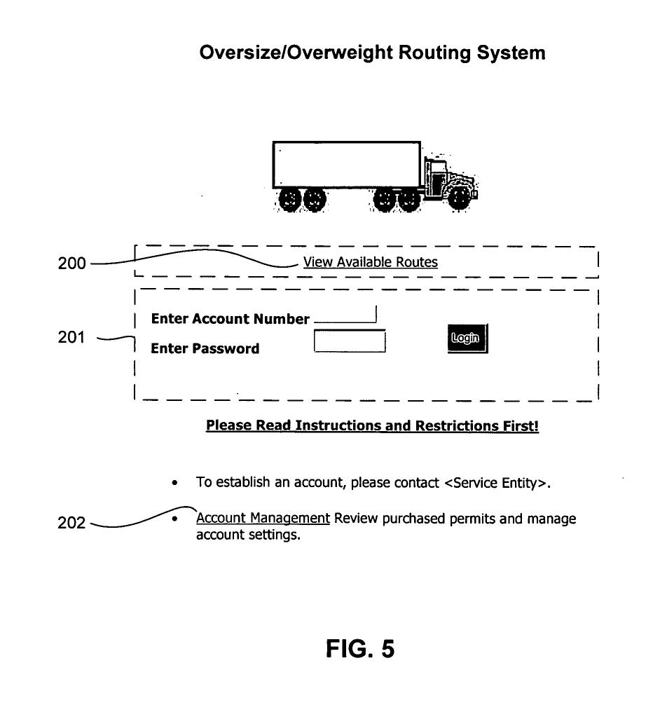

Referring now to FIG. 2A, the user is first presented with a login/registration web page at step 2. A non-limiting example of a login/registration web page as shown in FIG. 5. Prior to being able to access the vehicle routing and permitting system 100, the user may either log into the service entity's login/registration page by entering a user identification and password, or alternatively register as a new user of vehicle routing and permitting services. If the user is a registered user, meaning that the user has previously registered and has been approved by the service entity 102, then the user may simply provide the service entity 102 with user identification and an associated password each time the user desires to access the vehicle routing and permitting system 100. As can be seen in FIG. 5, a registered user enters the user identification and associated password into user-modifiable data fields 201, and then clicks a Login button to cause the entered information to be submitted to the service entity 102. It is this login information that allows the service entity 102 to access the user account and registration information profile in the user entity account and insurance database 111.

When a registered user enters user identification and a password, the service entity 102 receives this login information and processes it with respect to the user entity account and insurance database 111. For example, the processor 125 may access the user entity account and insurance database 111 to locate the entry corresponding to the user identification. If no corresponding entry is found in the user entity account and insurance database 111, an error message is returned to the user. If a corresponding entry is found, a password corresponding with the entry in the user entity account and insurance database 111 is compared to the password provided in the login information. If a match is not found, an error message is returned to the user. If a match is found, the user is successfully identified and is granted access to the vehicle routing and permitting system 100.

However, if the user accessing the login/registration webpage is not registered, the user may contact the service entity 102 and/or jurisdiction and service entity group 116, which may optionally require written signatures and/or waivers related to the use of the system and be effected through the completion of a form that is transmitted to the user by mail, fax, email or other suitable transmission method. The service entity 102 and/or jurisdiction and service entity group 116 assigns the user identification and a temporary password that the user can change after log in. The service entity and/or jurisdiction entity group also retains the right to suspend or revoke account privileges for any given user within their jurisdiction.

As a variant, and providing it meets the requirements of any applicable laws and the operating intentions of the applicable members of the jurisdiction and service entity group 116, it is possible that the registration between the user and the service entity 102 may be effected entirely through automated means contained within a module related to the login/registration web page. These methods will be readily apparent to the reader skilled in the art.

Assuming that the application for registration is granted and initiated by the service entity 102 and/or jurisdiction and service entity group 116, at step 3 the user entity account and/or insurance information is retrieved, and at step 4 this information is checked for validity. The user entity account and insurance database 111 includes information pertaining to the user entity registered with the service entity 102. For each user, an entry may be provided, including various information describing and/or otherwise associated with the user. Each entry may include an entity identifier and/or a corresponding password. Each user entity identifier may be associated with a respective user entity profile, including user entity characteristics that may be used by software at the service entity 102 to validate insurance requirements, if any, and alter the identities of the billing contact and the certificate recipient. As a variant, the act of a single logon using a user identifier and password may not be required for the user to access the vehicle routing and permitting system 100. In this variant, a trusted user (e.g., an employee or other trusted user belonging to the service entity 102) may access multiple user entity profiles and fully interact with the vehicle routing and permitting system 100.

### Display User, Input Recipient Identity, Select Permit Type (Step 1200)

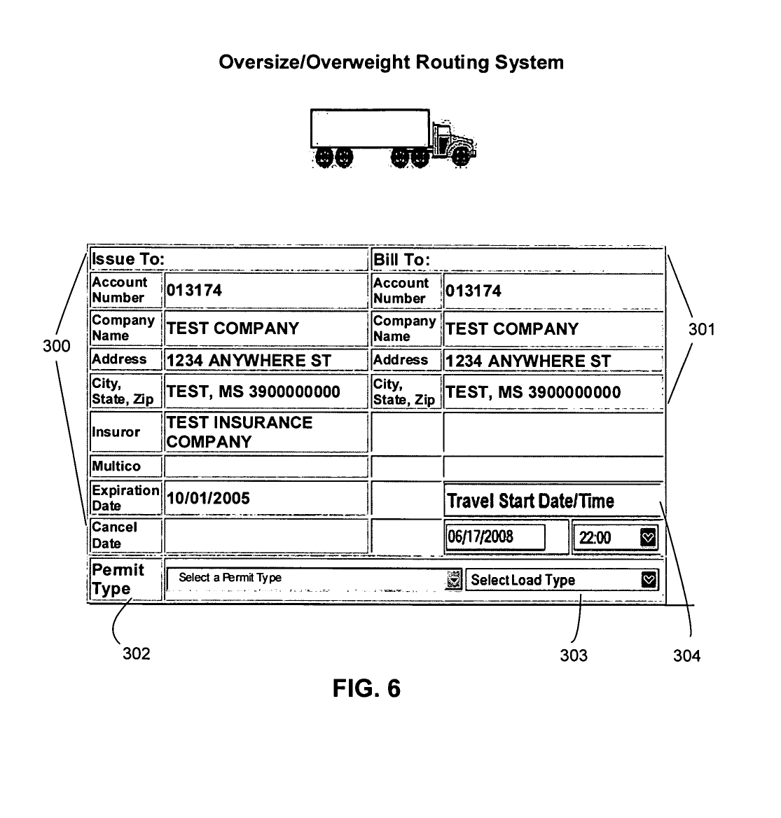

Once the user has been successfully identified by the login process, a non-third party or direct registered user profile of the user entity computing unit 103 may download a module displaying the billing and registration information of the direct user permit recipient. In this example, an illustrative user interface screen corresponding to a direct user entity profile is shown in FIG. 6, which corresponds to step 9 in FIG. 2A. In the event that that the user has a third party profile, the computing unit 103 downloads a module displaying a search or edit function to locate or input (step 6) a registered user entity that is retrieved from the user entity account and insurance database 111 (step 7), who is intended to be the permit recipient.

Referring to FIG. 6, user entity billing information 301 and certificate recipient information 300 is retrieved is displayed for the user, and in step 10 the user is prompted to select a permit type, and enters the vehicle load type and intended travel date(s) and time(s) using input fields 302, 303 and 304, which may be implemented as text fields and/or drop-down lists. Permit types may include, but are not limited to legal, oversize and/or overweight, mobile home oversize, and trip permit types. Trip permit may also be added to any of the above permit types. Vehicle configuration and load type may be added to any of the above permit types. This list is but an example of one implementation, and other permit types may be added or substituted in accord with the broad aspects of this invention. Responsive to the permit type being selected by the user, the selected permit type is submitted to the service entity computing system 108.

### Input Load Information, Physical Vehicle Criteria and Travel Date (Step 1300)

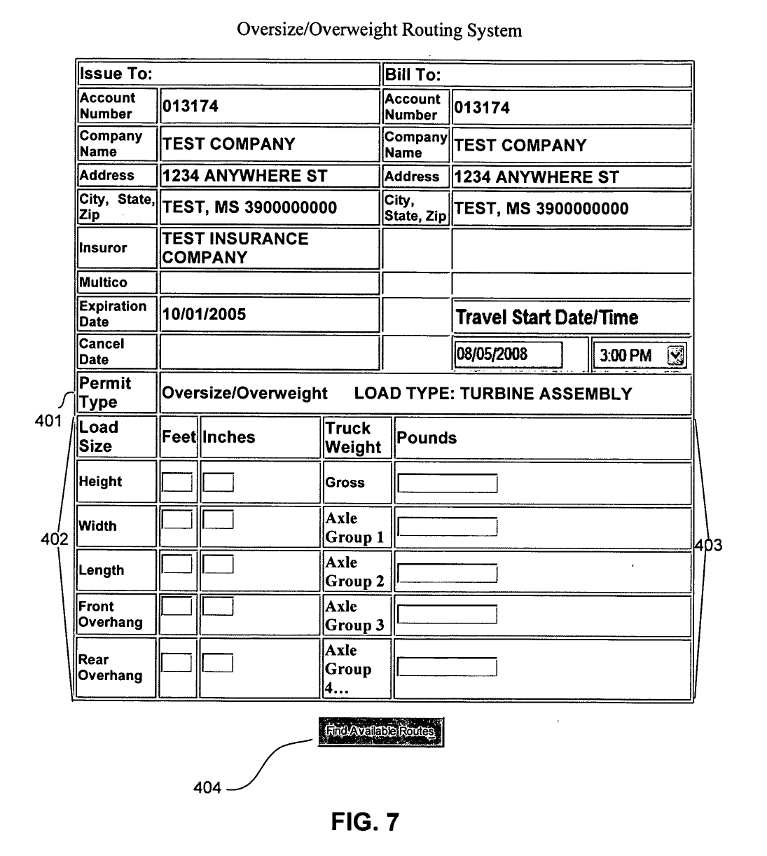

Once the user has selected the permit type and submitted it to the service entity computing system 108, the service entity computing system 108 and the application and program elements 109 processes the permit type selection and generates a user interface screen, such as the screen shown in FIG. 7, which includes the selected permit type. The user interface screen may further include one or more editable fields that are specific to the permit type selected 401. The user interface screen may further include fields 402 and 403 that the user may populate with information. Such fields may include editable fields 402 for vehicle height, width, length, front overhang, rear overhang, as well as editable fields 403 requesting gross weight, axle group 1 weight, axle group 2 weight, axle group 3 weight, axle group 4 weight information. Portions of this editable information or any additional editable information may be displayed in other variations of this illustrative implementation. Additionally, although the present example displays editable information in commonly used English measurements of feet, inches and pounds, the system may alternately display and accept information according to metric standards or in other units of measurement.

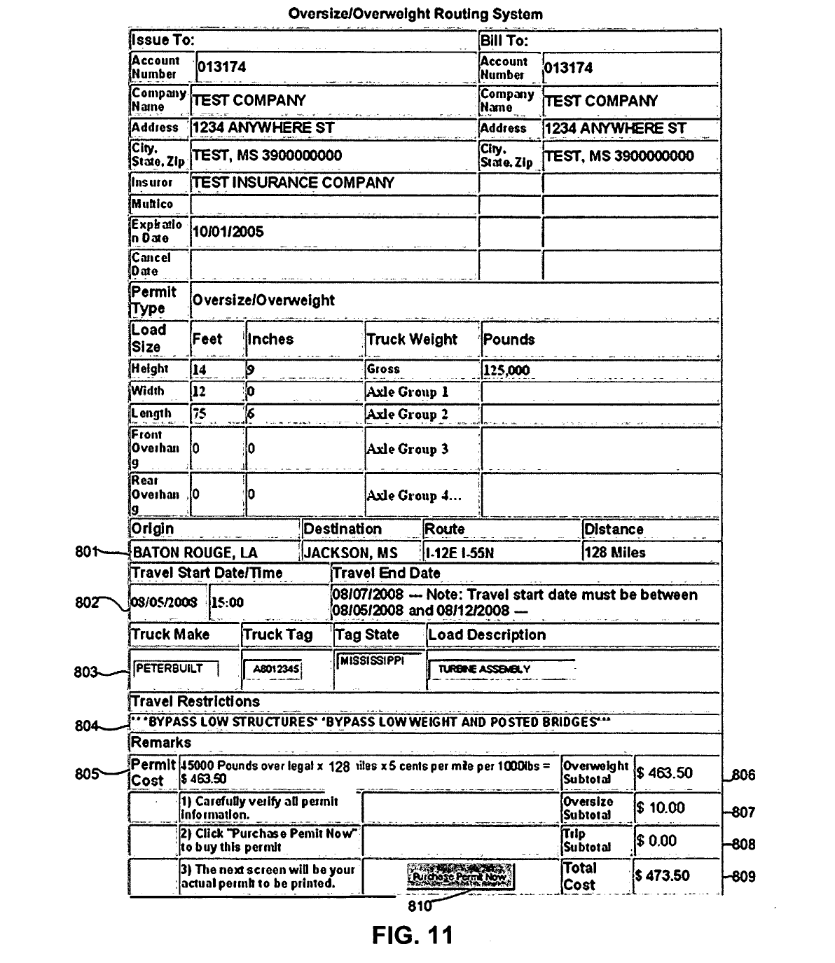

Once the requested information is input by the user, the user may select a displayed “Find Available Routes” button 404 function, to submit the information to the service entity computing system 108. In response, the application and program elements 109 verifies the information for completeness and validity as shown in FIG. 2A, Step 22. If the data is incomplete or if any element is outside of the global parameters that may be defined, the service entity computing system 108 and the application and program elements 109 return the user to the input travel date(s) and time(s), load information, and physical vehicle criteria screen in FIG. 7 (step 12), and redisplays the editable information input by the user entity with error indicators specifying the discrepancy. However, if the information entered by the user is valid and all elements are within the global parameters, the service entity computing system 108 and the application and program elements 109 process the information against the system route segment, segment collection and route database 112. In an alternate example, some permit types may not require routing, i.e. depending upon the permit selected, the vehicle may be allowed to traverse any route without specific routing. In this case, the user would be directed to a user interface screen such as that shown in FIG. 11 (steps 20 and 1500).

### Select Route (Step 1400)

If the information input in step 1300 is valid, a permit type requiring routing is selected by the user, and all information is within optional global parameters, then the service entity computing system 108 and the application and program elements 109 process the information against the system route segment, segment collection and route database 112. To perform such processing, the service entity computing system 108 and the application and program elements 109 execute a data query (step 13) to determine a traversable subset of all available routes that would allow a vehicle having the user input start date(s) and times(s), load information and vehicle physical criteria, (e.g., the dimensions and weights of the vehicle). For example, the one or more vehicle criteria limits for each available route segment, and/or segment collection and/or route is compared with the user inputs of load and/or travel date(s) and times(s) and/or vehicle physical criteria, and those routes that have vehicle criteria limits that encompass the vehicle criteria are determined. A vehicle criterion limit “encompasses” a user-specified vehicle criterion if a vehicle having the vehicle criterion would be allowable on all of the associated route segment(s) and segment collection(s) comprising the route. For example, where a route has segments all having a vehicle criterion limit that defines a maximum vehicle weight of at least X pounds, those vehicle criterion limits would be compatible with, or encompass, any vehicle weight of X pounds or less, but not of any vehicle weight of greater than a vehicle criterion limit of at least one of the segments of the route.

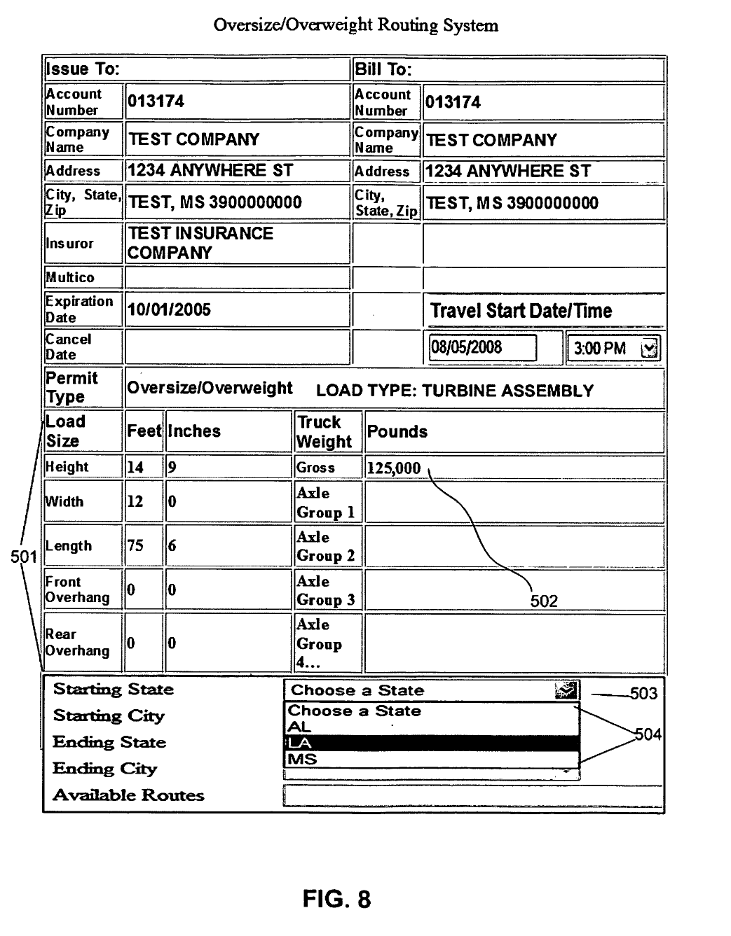

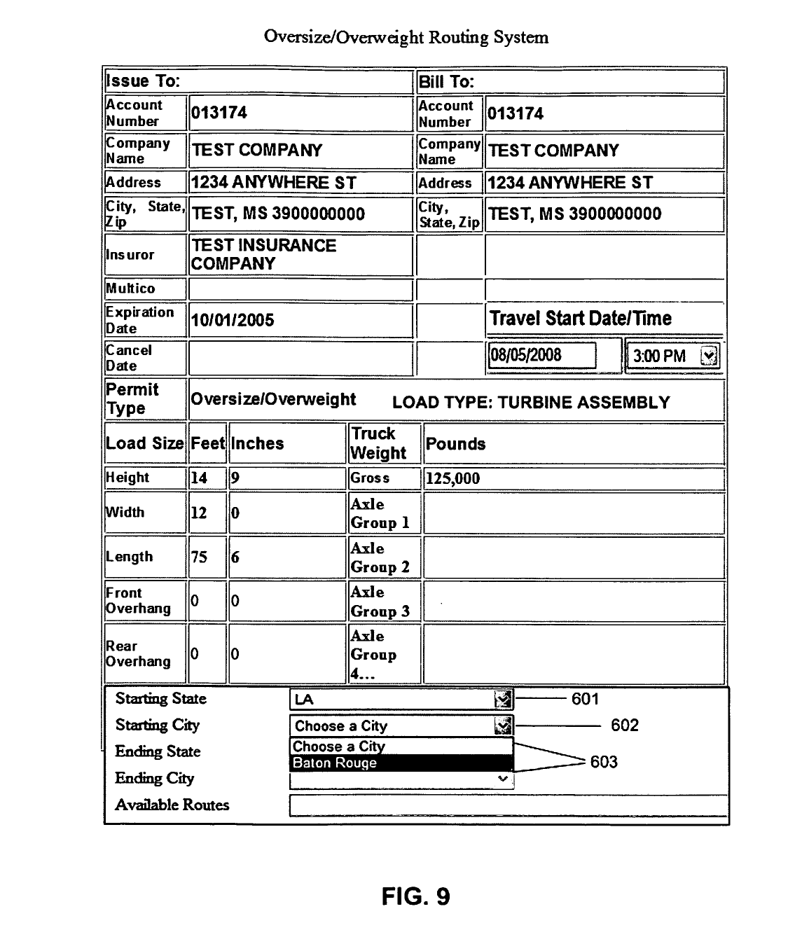

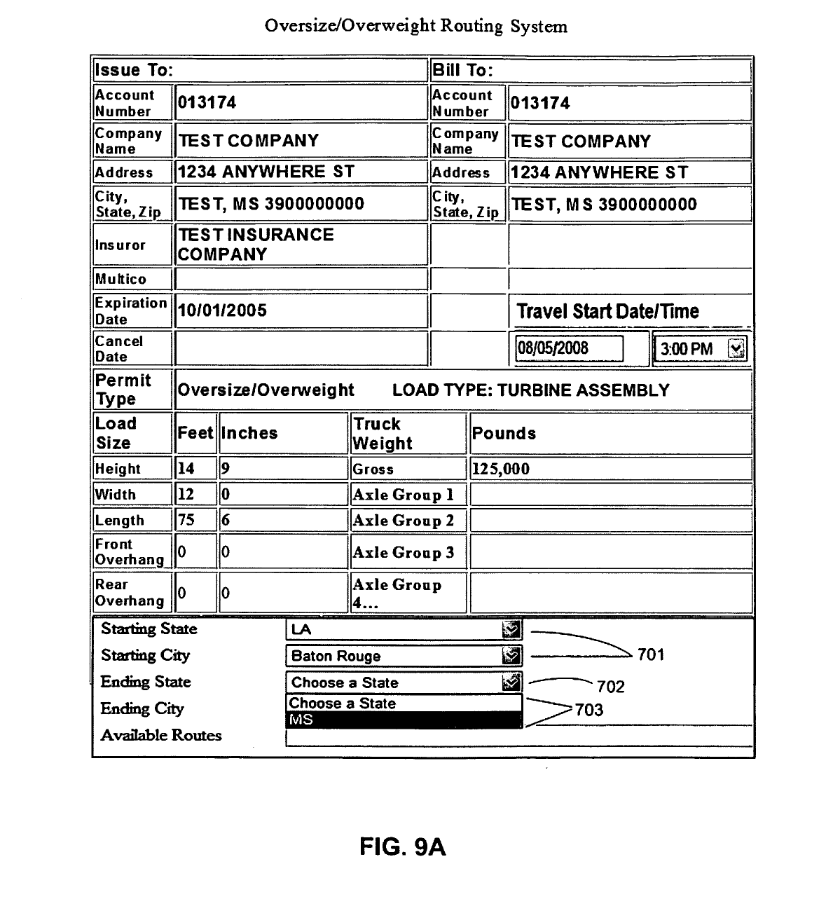

Once this subset of routes is determined using the criteria input in FIG. 6, items 302, 303 and 304, and FIG. 8, items 501 and 502, then a set of all of the origins defined by those routes may also be determined and displayed to the user (steps 13 and 14); such as shown in FIG. 8, item 504 and FIG. 9, items 601, 602 and 603. In this non-limiting origin list example, this origin selection process is deductive in its function, which allows precise locations to be queried and displayed 602 and 603, and selected 601 in the vicinity of a general origin 503. Duplicate origins may be removed from the list of found origins 504 and 602, and the listed origins may be presented in any order, such as alphabetically. The system can alternatively be configured to display all existing origins, whether routes emanating from the origins can encompass the user input physical vehicle criteria or not, but with only the traversable routes being able to be selected by the user entity.

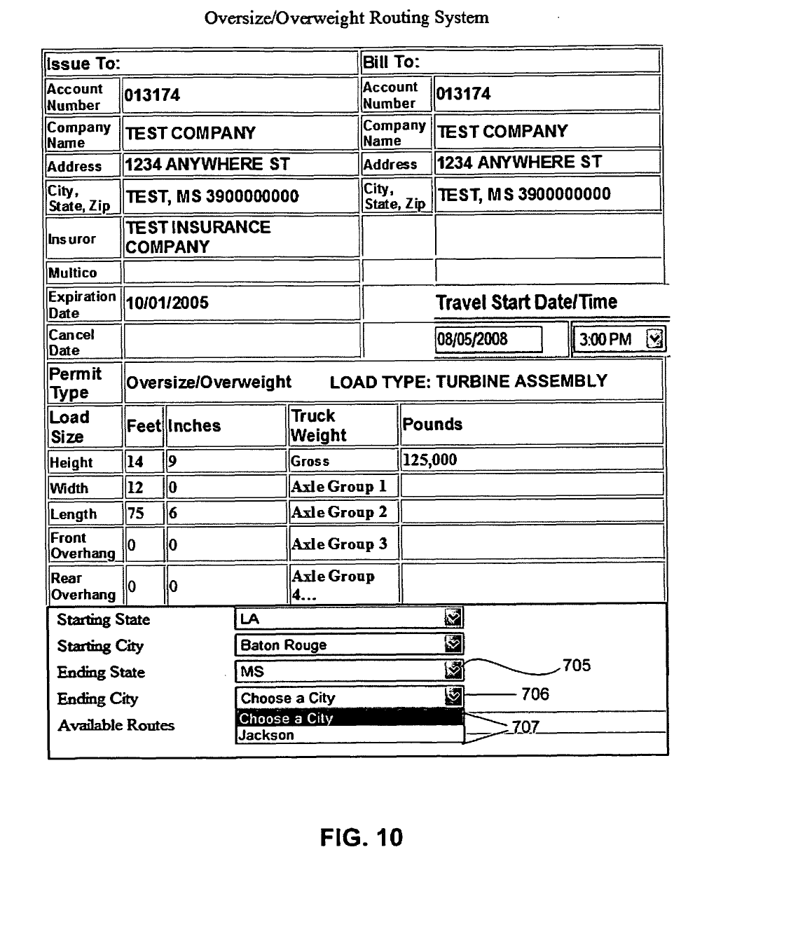

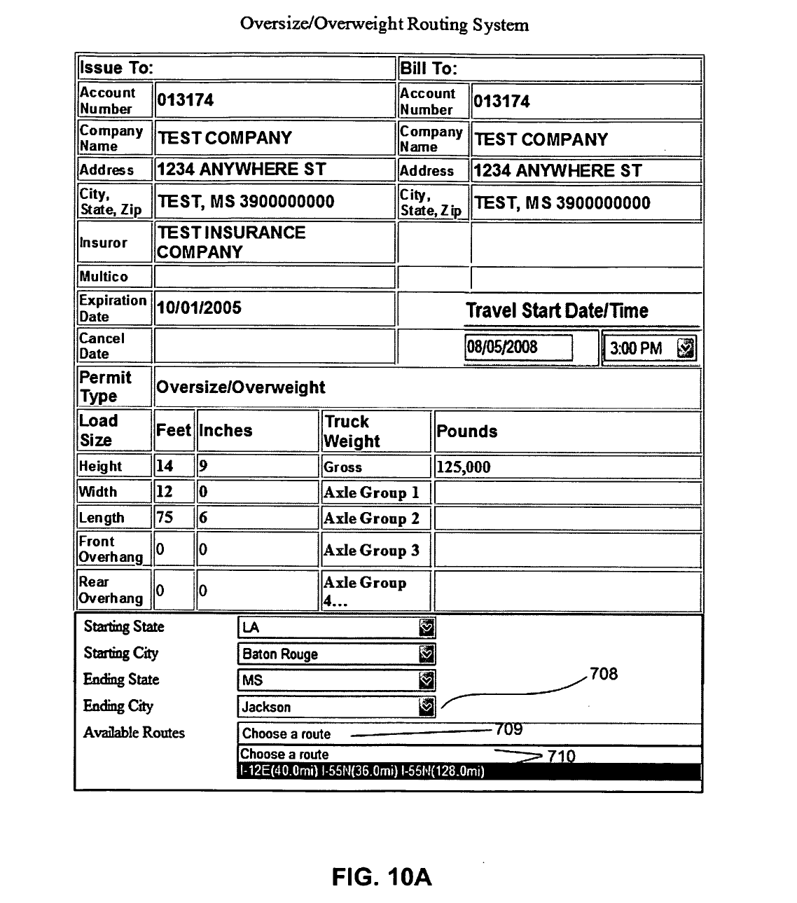

Responsive to the user selecting one of the origins from the lists 504 and 603 (steps 13 and 14), and displayed in FIG. 9A, Item 701, a third data query is executed in step 15 on the system route segment, segment collection and route database 112, which finds all available destinations 702 and 703 traversable from the selected origin with routes that have vehicle criteria limits that encompass all of the user-specified physical vehicle criteria. In this non-limiting destination list example, this destination selection process is deductive in its function, which may allow precise destinations 702 and locations 703 to be queried and displayed such as shown in FIG. 10, Items 706 and 707, and selected 707 in the vicinity of a general destination 705. Duplicate destinations may be removed and the user may be presented with the displayed identity of the previously selected origin 601 as well as a list 603 of the destinations determined in step 15. The list of destinations may be presented in any order, such as alphabetically, and may be viewed by the user via drop-down controls 703 and 707.

The user then selects one of the destinations in the displayed lists 703 and 707. In response, a fourth data query is executed in step 17. The fourth data query searches the system route segment, segment collection and route database 112 (e.g., using a database query) for all qualifying individual route segment(s), segment collection(s) and complete route(s) between the user-selected origin and the user-selected destination in order of total route distance. A qualifying route is a route in which its vehicle load type, travel date(s) and time(s), and vehicle criteria limits encompass all of the user-specified criteria, with all traversable segments and collections indicated to be traversable with respect to these user-specified parameters. A user interface screen such as that shown in FIG. 10A is then presented to the user. The screen of FIG. 10A shows the selected origin, the newly-selected destination 708, and a list 709 and 710 of the route segments, segment collections and/or routes found in the third data query search of step 17. The user then selects one of the route segment(s), and/or segment collection(s) and/or route(s) shown in the list 710 (step 18). Item 709 may be, but is not limited to the form of a drop-down list 710, or graphical display such as a map. The routes may be displayed in the list 710 in any order, such as in ascending order by total route distance, cost, roadway type (e.g.; Interstate only, U.S. Highway only, Toll Road), alphabetically, or by frequency of use.

During interaction with any of the user interface screens described herein, the user has the ability to step backward and modify the user's choices for any of the information that the user has provided. The new information would then be reprocessed, and alternative responses would be displayed. It should be readily apparent to the reader skilled in the art that different origins, destinations, and routes will be shown in the various user interface screens described herein, depending upon the user input of physical vehicle criteria.

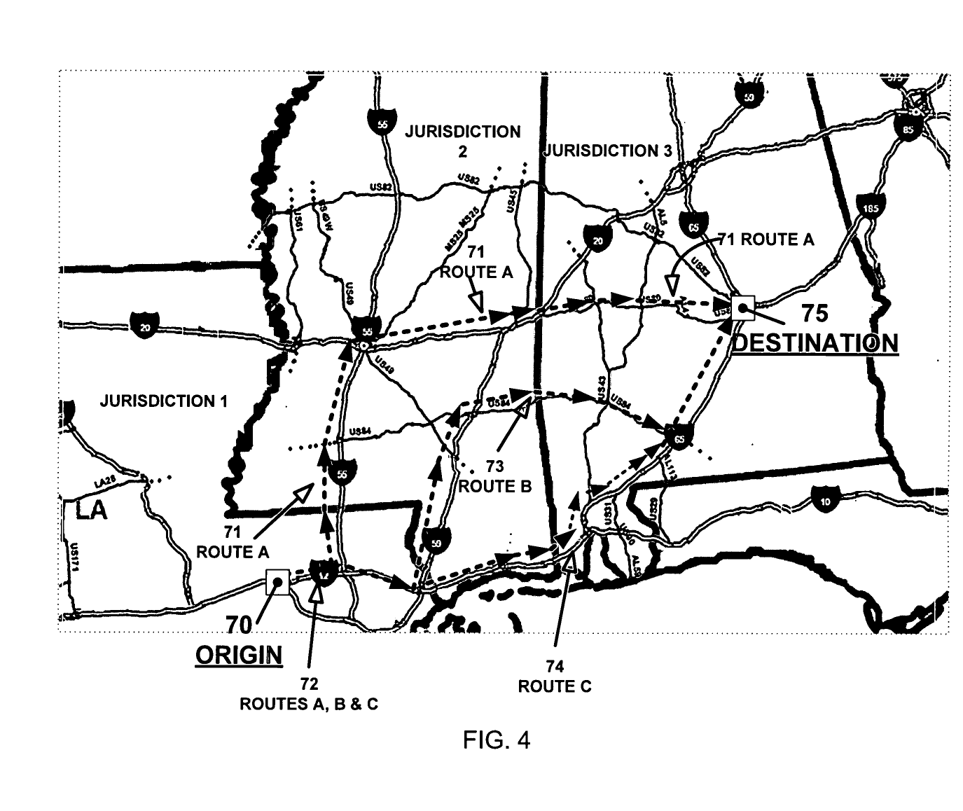

Referring now to FIG. 4, an illustrative map is shown containing an origin and a destination encompassing three jurisdictions, with a plurality of route segments and segment collections comprising three routes between them: Route A, Route B, and Route C. This map is shown merely for illustrative purposes and is not necessarily displayed to the user. However, such a map may be displayed to the user if desired. Each of these routes A, B, and C in this example is associated with one or more respective vehicle criteria limits. For example, Route A may have an associated vehicle criteria limit that defines a maximum allowable vehicle height of 16.0 feet for that route. Route B may have an associated vehicle criteria limit that defines a maximum allowable vehicle height of 15.0 feet for that route. Route C may have an associated vehicle criteria limit that defines a maximum allowable vehicle height of 14.0 feet for that route. Assume that Route A is 420 miles in length; that Route B is 440 miles in length, and that Route C is 360 miles in length. The shortest route (Route C) may be preferable to the user, but if in this example the user is attempting to route a vehicle from the specified origin to the specified destination that is 14.5 feet in height, Route C would not be provided to the user as an option. This is because the vehicle criteria limits of Route C are not compatible with (do not encompass) the user-specified vehicle criterion of 14.5 foot in height. Instead, Routes A and B, which do have vehicle criteria limits that encompass the user-specified vehicle criterion, would be provided to the user to choose from. In this example, the user may choose Route A because it would be the shortest available route. On the other hand, if the user is routing a vehicle from the specified origin to the specified destination in this example that exceeds 15.0 feet in height, but does not exceed 16.0 feet in height, Route A would be the only available route. Finally, if the user is routing a vehicle that exceeds 16.0 feet in height from the specified origin to the specified destination in this example, there does not exist a traversable route, and so no routes are displayed. In fact, the particular origin itself may also not be displayed as a selectable origin to the user since there would be no traversable routes emanating from the origin in accordance with the user-specified vehicle criterion.

Input Vehicle Registration Information (Step 1500)

In step 19, the service entity 102 may automatically calculate fees based on the user route selection, the total distance of the selected route, the user-specified vehicle criteria, and/or other information associated with the selected route. Referring to the illustrative user interface screen of FIG. 11 (step 20), the user is presented with an itemized set of costs 805, 806, 807, 808, 809 cost of each fee type as well as displaying intended travel date 802 and load description 803 and/or being required to complete the remaining vehicle identification information 803, such as but not limited to vehicle make, vehicle tag, tag state and additional descriptive information regarding the vehicle. Additionally, travel restriction information 804 may be based on physical vehicle criteria and route criteria information, including advisories or comments being displayed.

In step 21, the information input by the user is validated by the service entity 102, and if the information is determined to be valid at step 22, then a preview of a permit certificate is displayed, which allows the user to confirm all information and determine whether to purchase the permit and receive the certificate. However, if the information is determined to be invalid in step 22, the user is returned to step 20, where the previous user input information is redisplayed with an opportunity to edit the information. Also, error indicators are displayed specifying the discrepancy or discrepancies in the user input information. Additionally, route, distance and cost subtotal information 806, 807, 808 based on physical vehicle criteria and route criteria information may also be itemized by jurisdiction and fee schedule.

### Confirm Purchase (Step 1600)

For security reasons, the user may be given a time limit (e.g., 60 minutes) to complete a permit from start to finish, after which the permit session will be invalidated and the user entity must begin from step 2. However, assuming that the user has correctly completed the permit application form and selects a purchase button 810 within the time limit, the user input information is validated, the transaction is recorded to the user entity transaction database 113, and a unique permit identifier and/or identifiers are generated in step 25.

View/Transmit/Print Certificate (Step 1700)

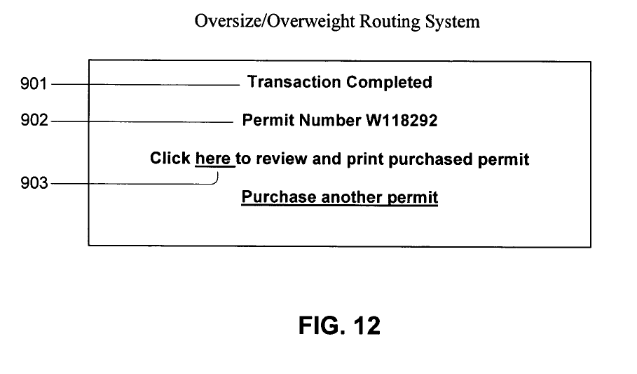

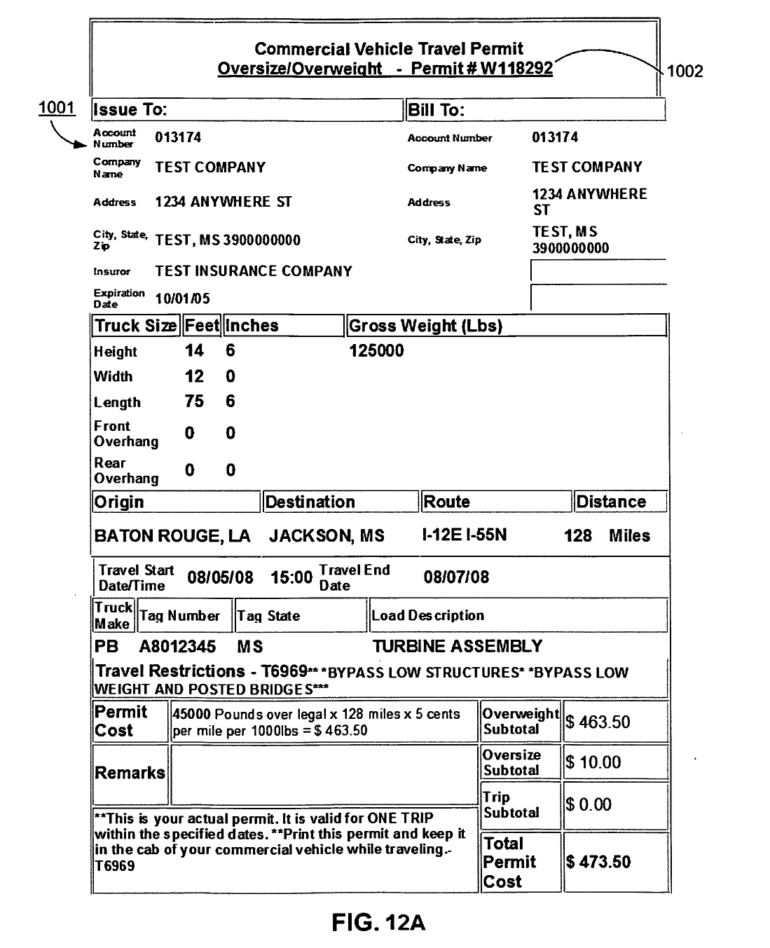

The service entity computing system 108 then displays a confirmation form, such as that shown in FIG. 12, to the user. The completed transaction is confirmed 901 to the user, the unique permit identifier 902 is displayed, and the user is given an option 903 to view, transmit, print, or later recall the completed permit certificate in step 26. FIG. 12A shows an illustrative permit 1001 and unique permit identifier 1002, as displayed to the user. The user may also print out the permit 1001 onto physical paper, since a physical printout of the permit document typically must accompany the travel of the vehicle.

It should be readily apparent to the reader skilled in the art that this illustrative purchasing process is entirely automated at the service entity 102. However, in variations of this implementation, the service entity 102 may choose an implementation that requires a manual review by a service entity authorized employee or agent of the information submitted before permission to travel is granted. For example, a permit request may be marked for review and handling by a human, and may be placed in a queue for such purposes.

Login Jurisdiction and/or Service Entity Account

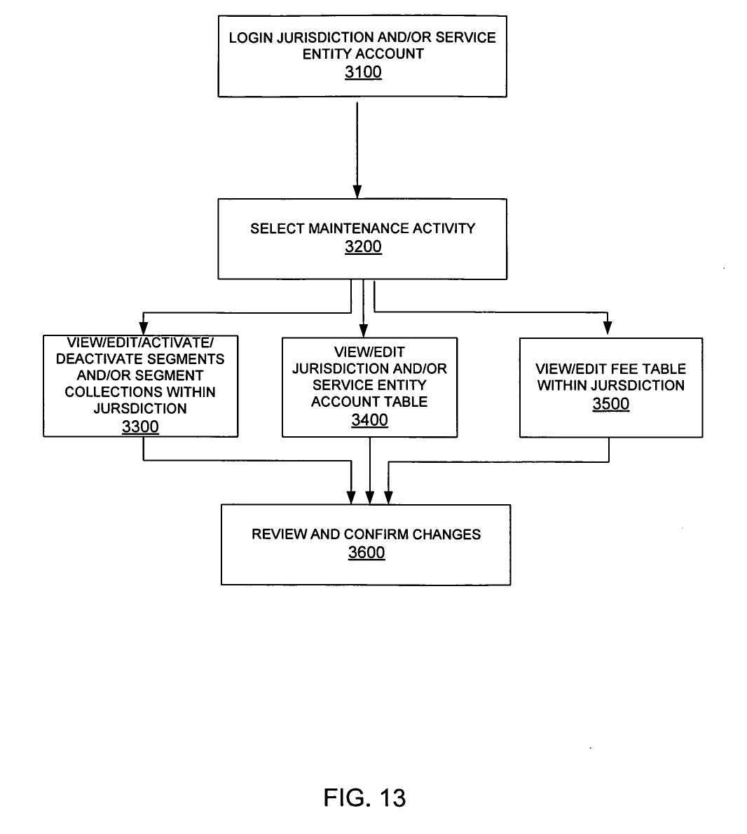

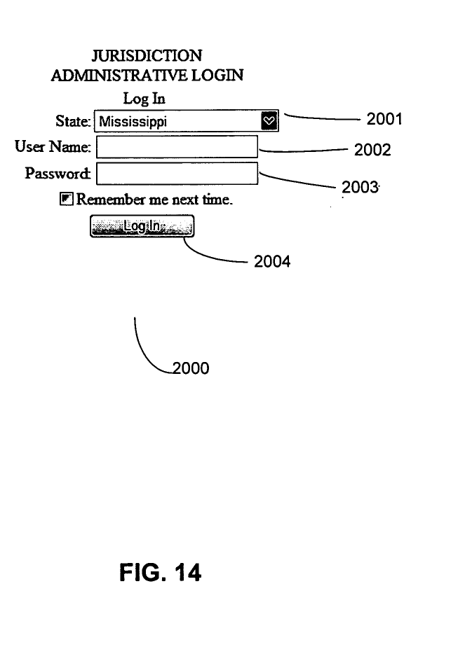

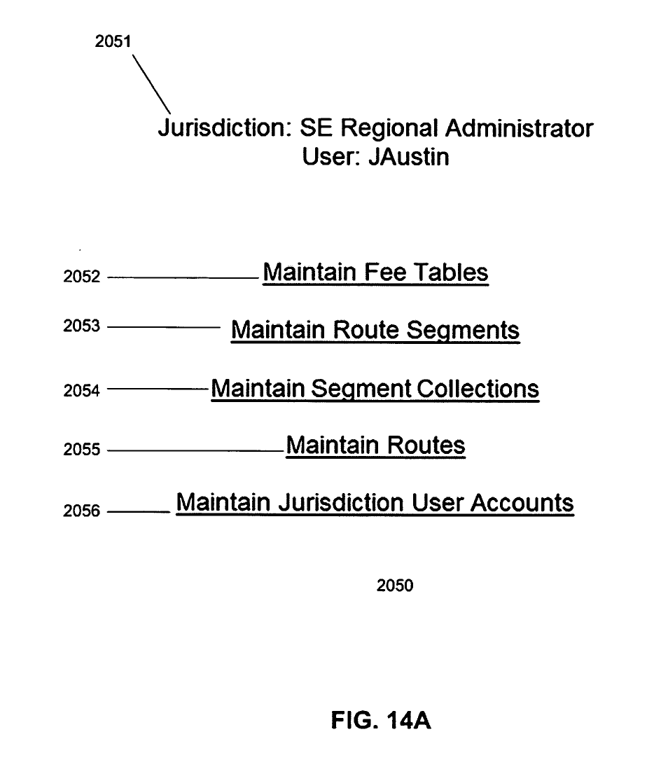

An illustrative interaction between the jurisdiction and service entity group 116 and the service entity 102 is described in relation to the administrative maintenance aspect of the vehicle routing and permitting system 100 according to an example of implementation of the present invention. With reference to FIG. 13, at step 3100 a jurisdiction and/or service entity user of the jurisdiction and service entity group 116 accesses a secure website (for example) of the service entity 102. In this example, jurisdiction and/or service entities may login and/or create jurisdiction user and/or service entity user accounts in the jurisdiction and service entity account database 114, via the application and program elements 109, and create and edit jurisdiction and/or service fee records in the jurisdiction and service entity fee database 115, or maintain individual route segment(s), segment collection(s) and/or complete route(s) in the system route segment, segment collection and route database 112. As shown in FIG. 14, the jurisdiction and/or service entity is presented with a login screen 2000, consisting of a jurisdiction and/or service entity drop down list 2001 indicating and allowing the jurisdiction and/or service entity to select the appropriate jurisdiction. Once the appropriate jurisdiction has been selected, the jurisdiction and/or service entity enters the user login name into the text box 2002, and appropriate password into the text box 2003, and presses the login button 2004 to validate the user's input credentials for that jurisdiction and/or service account against the credentials stored in the jurisdiction and service entity account database 114.

### Edit/Activate/Deactivate Segments and/or Segment Collections within Jurisdiction

Once the jurisdiction and/or service entity user has successfully submitted and validated their user credentials against the credentials stored in the jurisdiction and service entity account database 114 via the application and program elements 109, the jurisdiction and/or service entity user is then redirected to an administrative page whereby, depending on jurisdiction and/or service entity permissions stored in the jurisdiction and service entity account database 114 various data views and editable areas are displayed. As is illustrated in the non-limiting example, various user-selectable administrative features are displayed such as in FIG. 14A item 2050, such as jurisdiction and service entity fee structure modifications 2052 particular to the jurisdiction and/or service entity selected in the drop down list 2001, and/or route segment 2053, segment collection 2054 or route 2055 management options are displayed, which enable the viewing, creation, activation, inactivation and maintenance of individual route segment(s), segment collection(s), and/or complete route(s), and further may enable the alteration of route criteria and remarks. Additional functions may include the creation and administration of additional jurisdiction or service entity accounts 2056. As will be further described, a maintenance activity (FIG. 13, step 3200) is then selected from these administrative feature options.

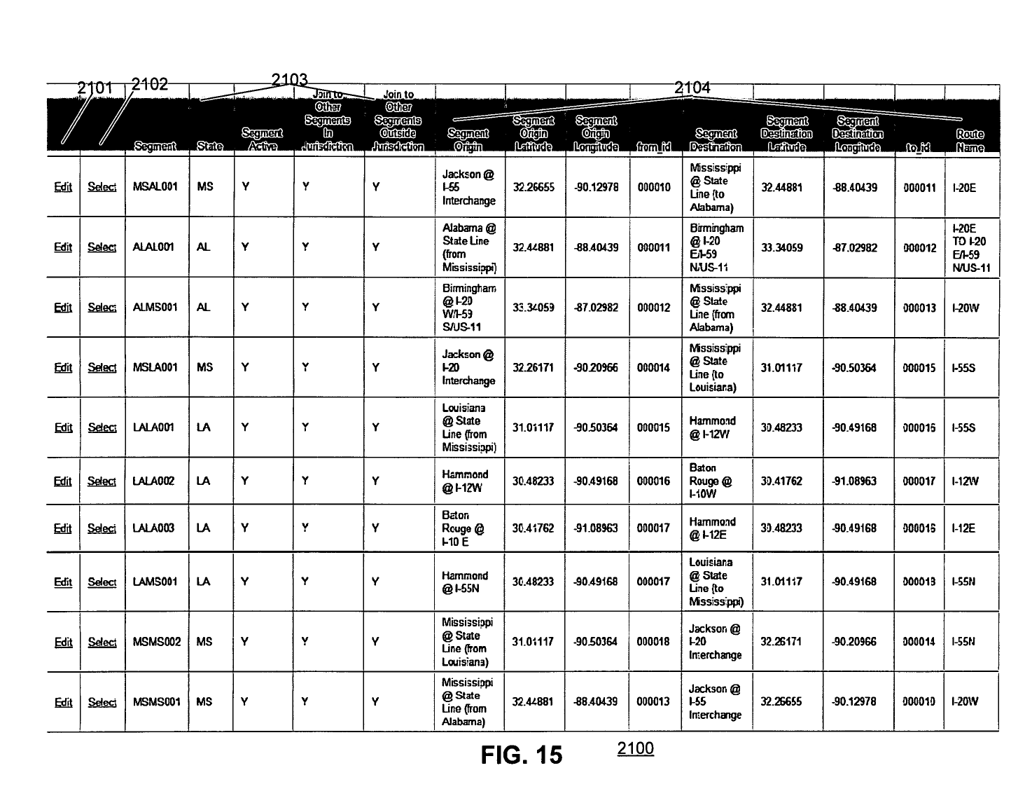

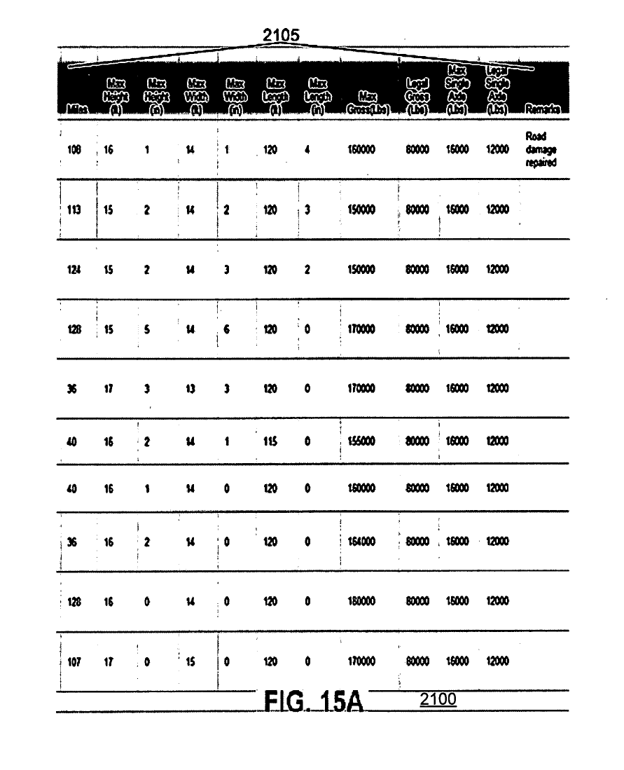

Referring again to FIG. 13, step 3300 and as further illustrated in FIGS. 15 and 15A, item 2100, a data view is displayed in response to the user selection of the maintain route segments option 2053, indicating whether the route segment is active and traversable, and able to be connected other segment(s) and segment collection(s) 2103, in addition, other details including jurisdiction location, geographic coordinates and other segment endpoint identifiers 2104 are shown, and finally other segment information and remarks 2105.

Each data view column in 2100 may be sorted or reorganized to display route segment information in sorted order, and/or can be filtered by criteria such as descriptive route name (e.g., “I-20”). In this non-limiting example, a regional administrator is able to view route segments belonging to multiple jurisdictions, however in other instances viewable route segments may be restricted to those within the jurisdiction and by only those who possess the appropriate authorization credentials for the jurisdiction

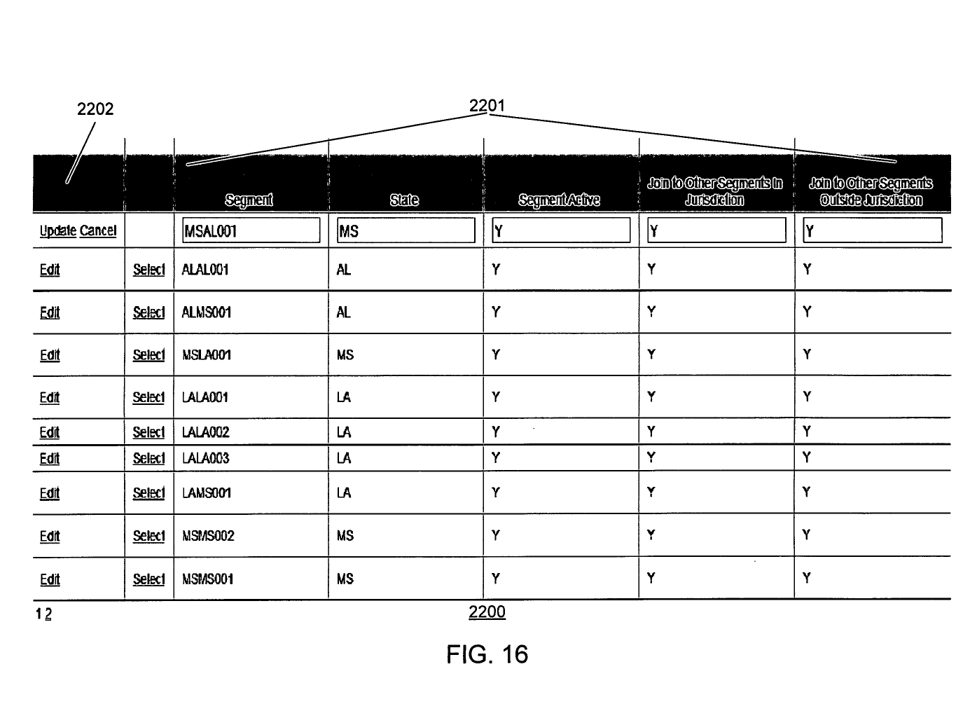

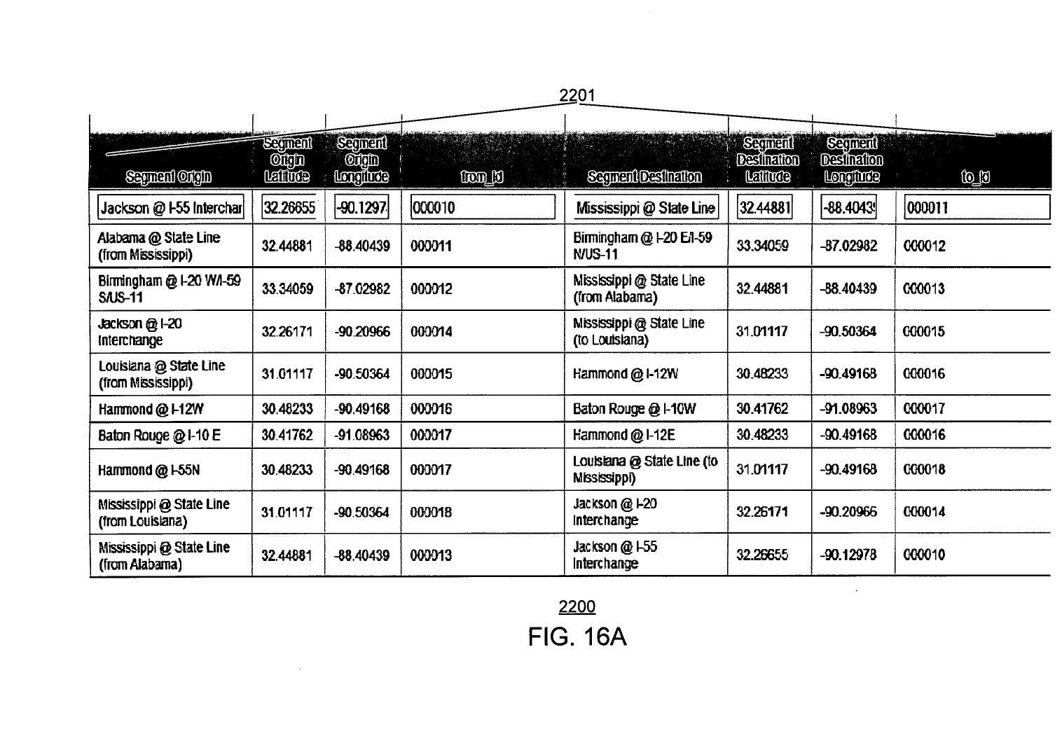

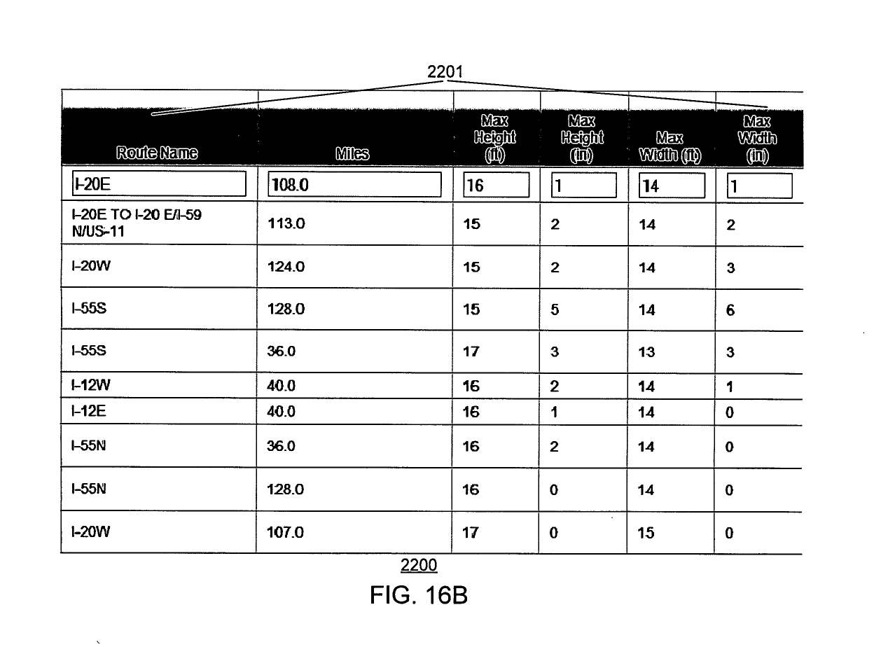

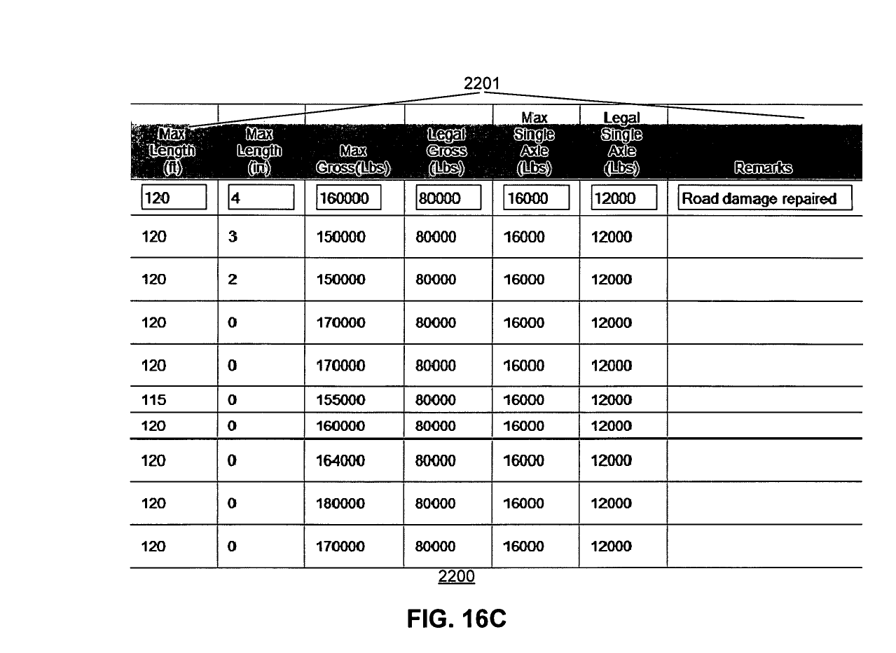

Providing that the jurisdiction and/or service entity credentials are sufficient, route segments can be displayed as editable, including route segment activation or deactivation information. This may be accomplished, for example, by selecting the edit link 2101 pertaining to the segment, which alters the view to allow the data elements in the segment to be edited such as is shown in FIGS. 16, 16A, 16B and 16C item 2200, which depicts an illustrative editable form of the data view with all data columns editable 2201. In the course of normal route segment maintenance, and depending on user and/or service entity permissions, certain fields may not be rendered in an editable form, such as endpoint information and route description information 2104. After the appropriate changes are made to the route segment details, the changes are then committed 3600 to the route table in the system route segment, segment collection and route database 112 by selecting the update function 2202, and the editable data grid is rendered as view only. If the changes are unwanted, a cancel link 2202 will render the editable data grid as view only without committing the data changes to the system route segment, segment collection and route database 112.

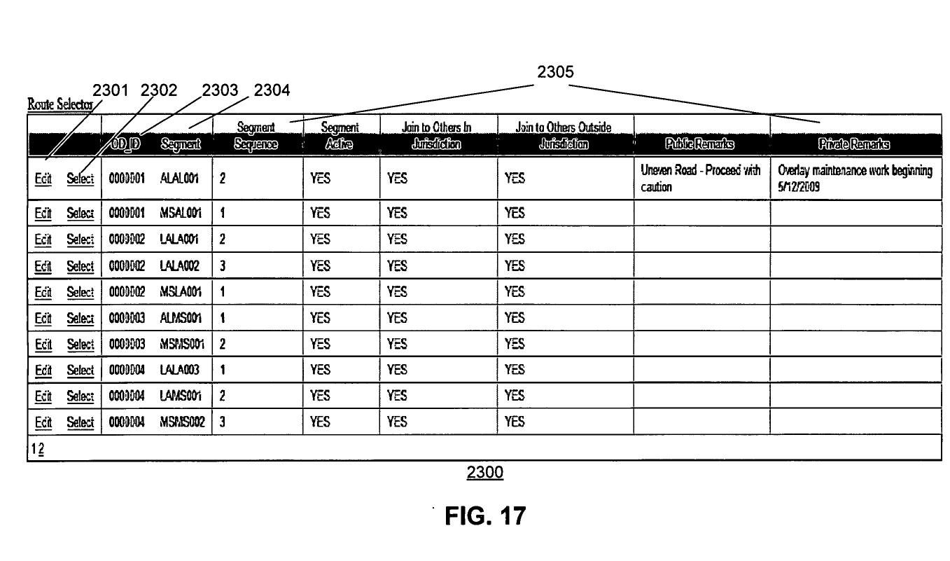

Referring to FIG. 17, item 2300, and in response to the user selection of the maintain segment collections option 2054, a data view is displayed indicating whether the route segment collection, which includes a unique identifier 2303 for each segment collection 2304, and one or a plurality of segments which may be connected by common endpoints, and includes additional information such as whether the route segment collection is active and traversable, and able to be connected to other route segments and segment collections 2305 as well as other details including a route segment sequencing number for traversal order as well as remarks.

Each data view column in 2300 may be sorted or reorganized to display route segment information in sorted order, and/or can be filtered by criteria such as unique identifier (e.g., 0000001) or whether the route segment is active and able to be traversed. In this non-limiting example, a regional administrator is able to view a route segment collection belonging to multiple jurisdictions, however in other instances viewable route segments, and/or segment collections and/or routes may be restricted to only those within the jurisdiction, and viewed by only those who possess the appropriate authorization credentials for the jurisdiction.

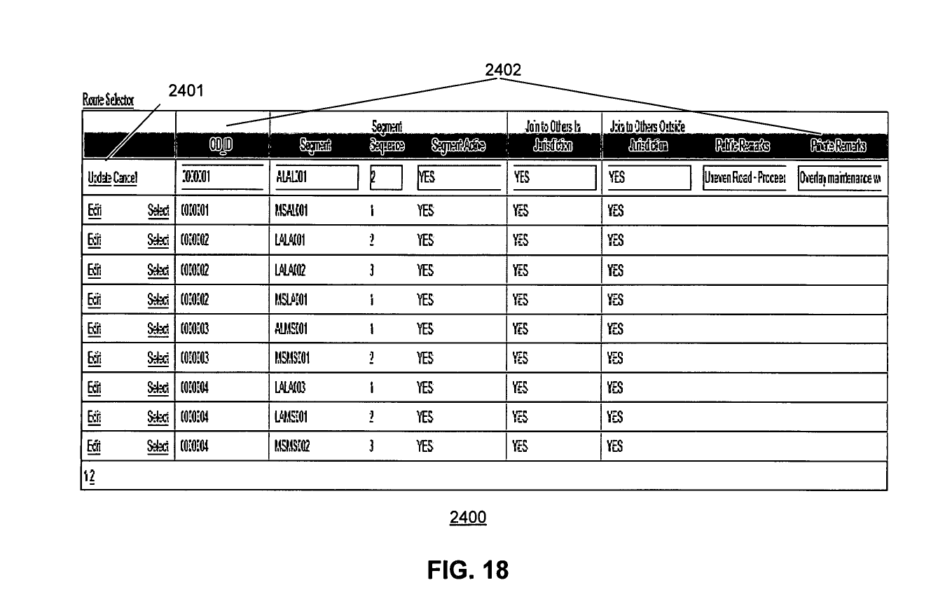

Providing that the jurisdiction and/or service entity credentials are sufficient, segment collections depicted in 2300 can be edited, including activation or deactivation of segment collection(s). This may be accomplished, for example, by selecting the edit link 2301 pertaining to each segment collection, which alters the view to allow the data elements in the segment collection to be edited such as is shown in FIG. 18 item 2400, which depicts an example of an editable form of the data view with all data columns editable 2402. In the course of normal route segment collection maintenance, and depending on user and/or service entity permissions, certain fields may not be rendered in an editable form, such as but not limited to unique identifier information, segment and segment sequence information. After the appropriate changes are made to the route segment details, the changes are then committed 3600 to the route table in the system route segment, segment collection and route database 112 via the application and program elements 109 by selecting the update function 2401, and the editable data grid is rendered as view only. If the changes are unwanted, a cancel link 2401 will render the editable data grid as view only without committing the data changes to the system route segment, segment collection and route database 112.

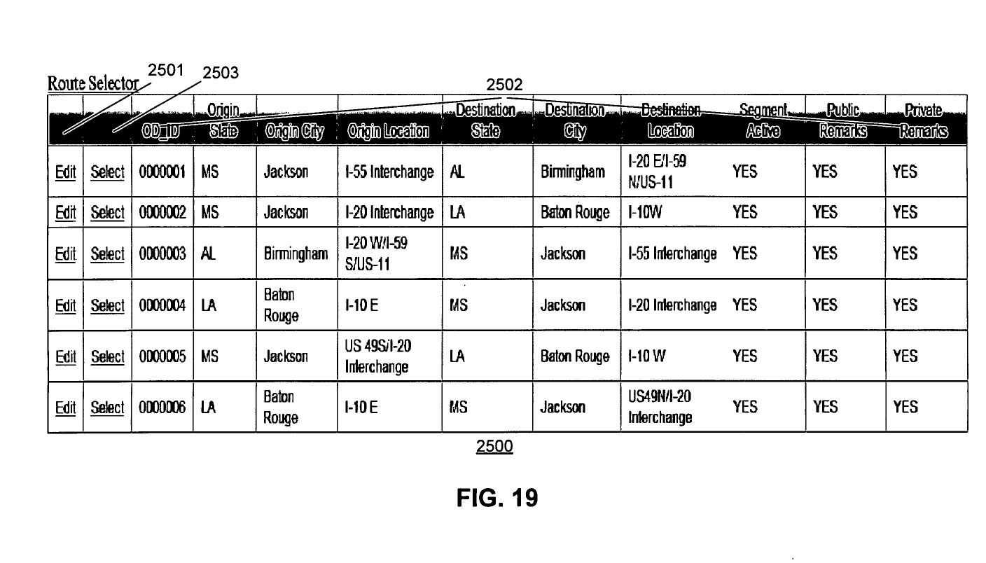

Referring to FIG. 19, item 2500, and in response to the user selection of the maintain routes option 2055, a data view is displayed indicating whether the route, which includes a unique identifier 2502 for each segment collection 2304, and one or a plurality of segments connected by common endpoints. This data view includes additional information such as whether the route is active and traversable, origin, destination, and remarks. It should be noted that the individual route segment(s) and/or route segment collection(s) and/or complete routes can be marked as to not be included in the route table and/or not be displayed during the process of route selection 1400.

Each data view column in 2500 may be sorted or reorganized to display route information in sorted order, and/or can be filtered by criteria such as, but not limited to unique identifier (e.g., 0000002) or whether the route is active and able to be traversed. In this non-limiting example, a regional administrator user is able to view routes that span multiple jurisdictions, however in other instances viewable routes may be restricted to only those within the jurisdiction, and viewed by only those who possess the appropriate authorization credentials for the jurisdiction.

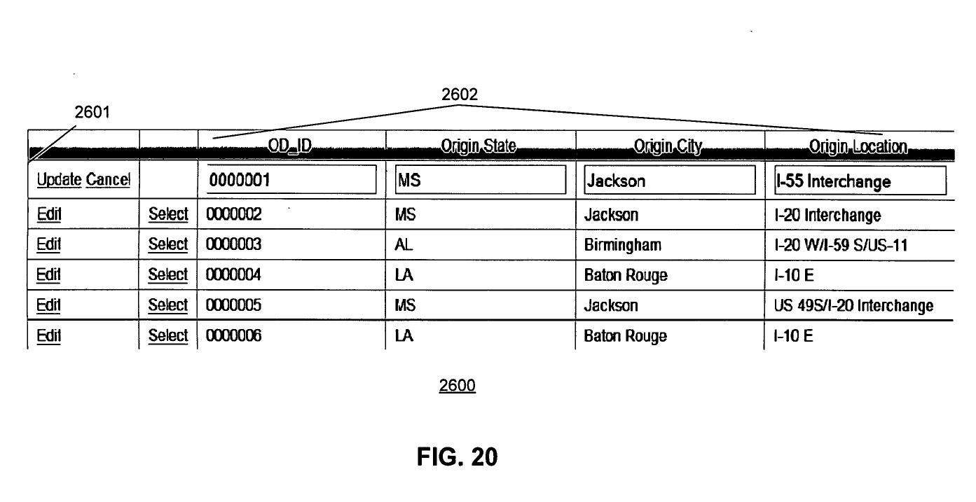

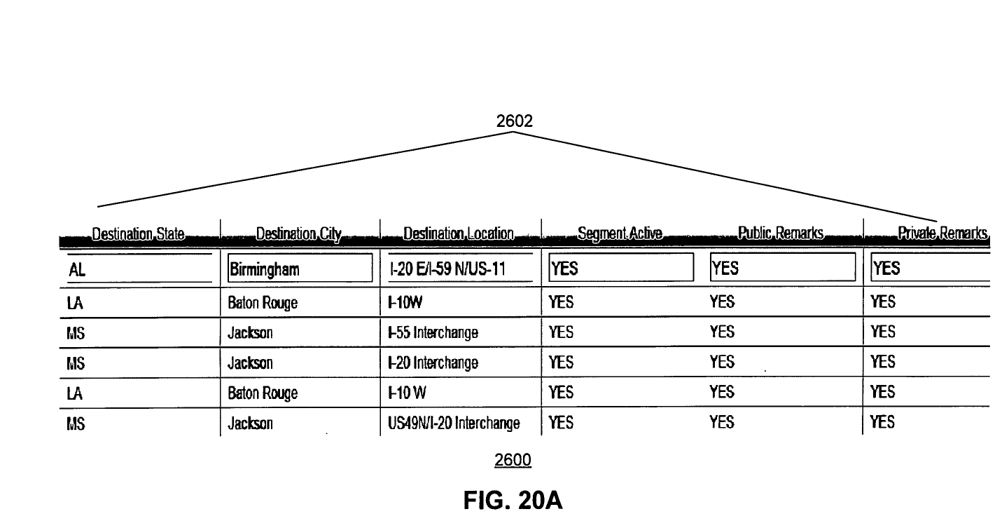

Providing that the jurisdiction and/or service entity credentials are sufficient, the routes depicted in 2500 can be edited, including route activation or deactivation. This may be accomplished, for example, by selecting the edit link 2501 pertaining to the route, which alters the view to allow the data elements in the route to be edited such as is shown in FIGS. 20 and 20A, item 2600, which depicts an example of an editable form of the data view with all data columns editable 2602. In the course of normal route maintenance, and depending on user and/or service entity permissions, certain fields may not be rendered in an editable form, such as unique identifier information, and/or origin and destination information. After the appropriate changes are made to the route information, the changes are then committed (step 3600) to the route table in the system route segment, segment collection and route database 112 by selecting the update function 2601, and the editable data grid is rendered as view only. If the changes are unwanted, a user-selectable cancel link 2601 will render the editable data grid as view only without committing the data changes to the system route segment, segment collection and route database 112.

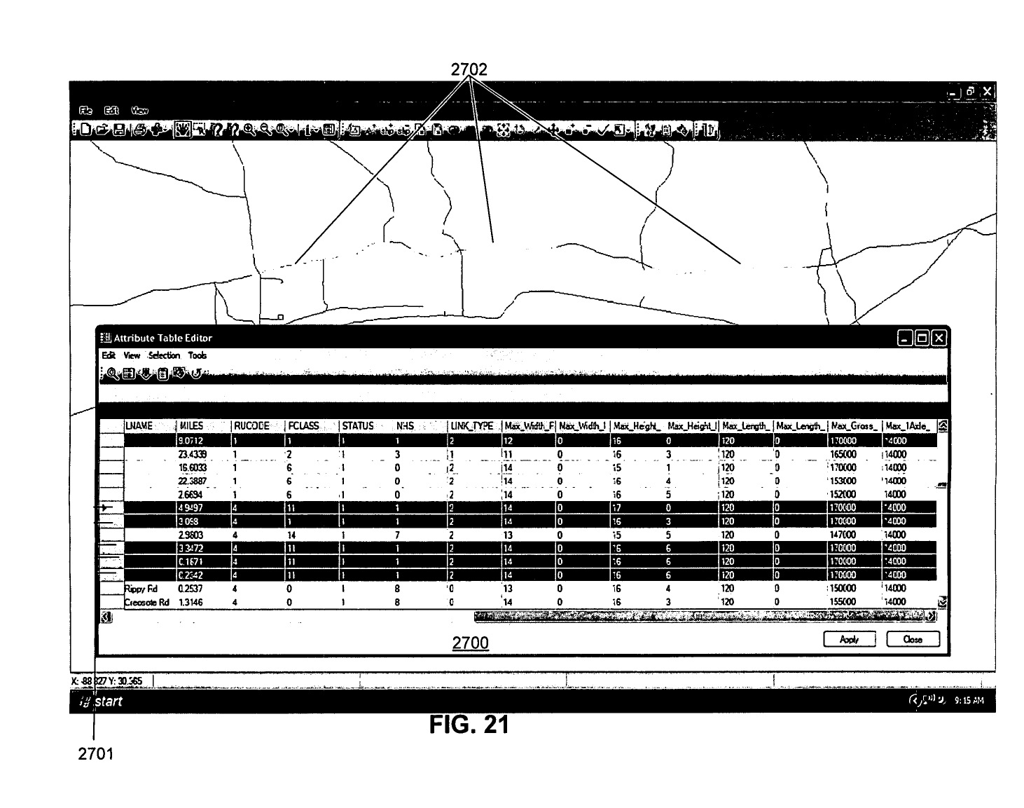

The route segment, segment collection and route maintenance functions may be displayed by choosing the select option 2102, 2302 and 2503 on each respective data view and may be displayed on a graphical map to illustrate the location of the route segment(s), segment collection(s) and/or route(s). This is shown by way of example in FIG. 21 item 2700. Individual segment details are displayed in data view 2701, and their respective locations on the graphical map 2702. Conversely, route segment(s), segment collection(s) and route(s) may be selected via graphical map 2702, and corresponding route segment, segment collection and route data may be viewed and altered such as shown in FIGS. 15 to 19, and previously described.

### Maintain Jurisdiction User Accounts

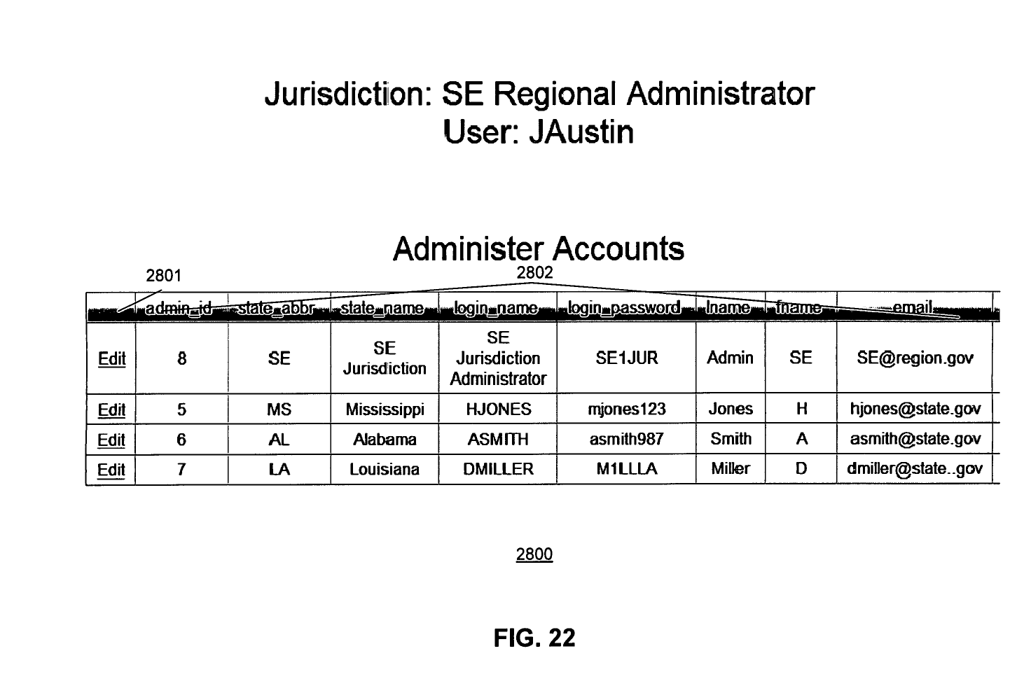

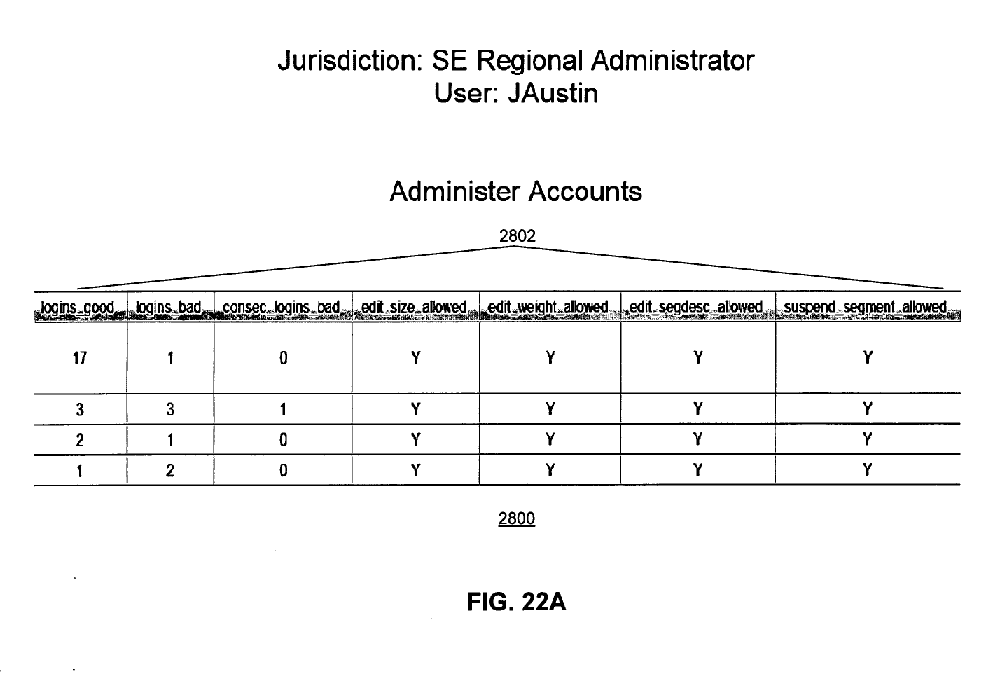

Referring to View/Edit Jurisdiction and/or Service Entity Account Table function 3400, and in response to the selection of the maintain jurisdiction user accounts option 2056, a data view illustrated by way of example in FIGS. 22 and 22A, item 2800, is displayed indicating the registered jurisdiction and/or service entity users and their assigned account privileges stored in the jurisdiction and service entity account database 114 via the application and program elements 109.

Each data view column in 2800 may be sorted or reorganized to display jurisdiction and/or service entity user information in sorted order, and/or can be filtered by criteria such as jurisdiction (e.g., MS) or account privileges and status. In this non-limiting example, a regional administrator is able to view jurisdiction and/or service entity user accounts belonging to multiple jurisdictions, however in other instances viewable jurisdiction and/or service entity user accounts may be restricted to only those within the jurisdiction.

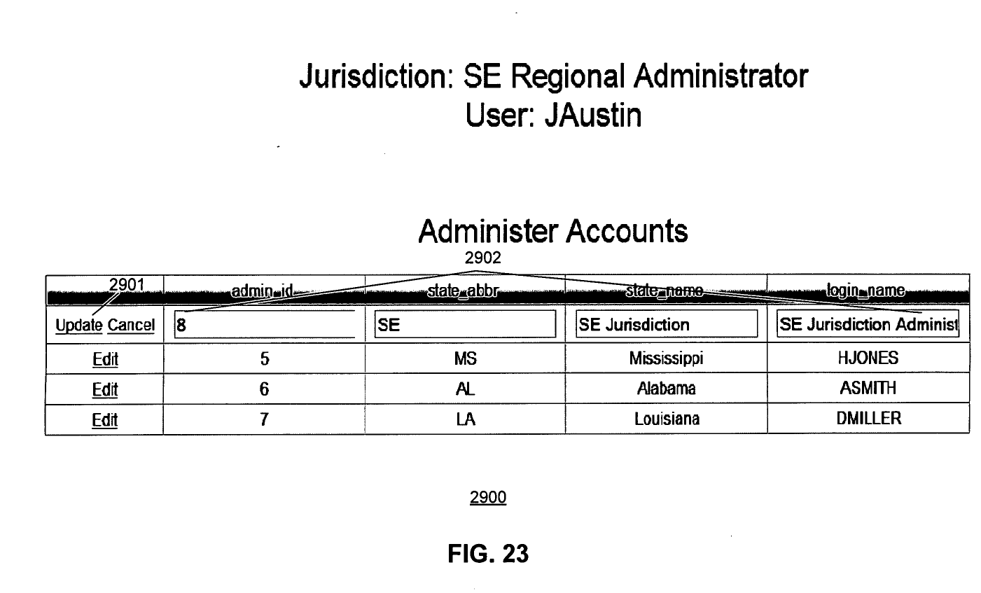

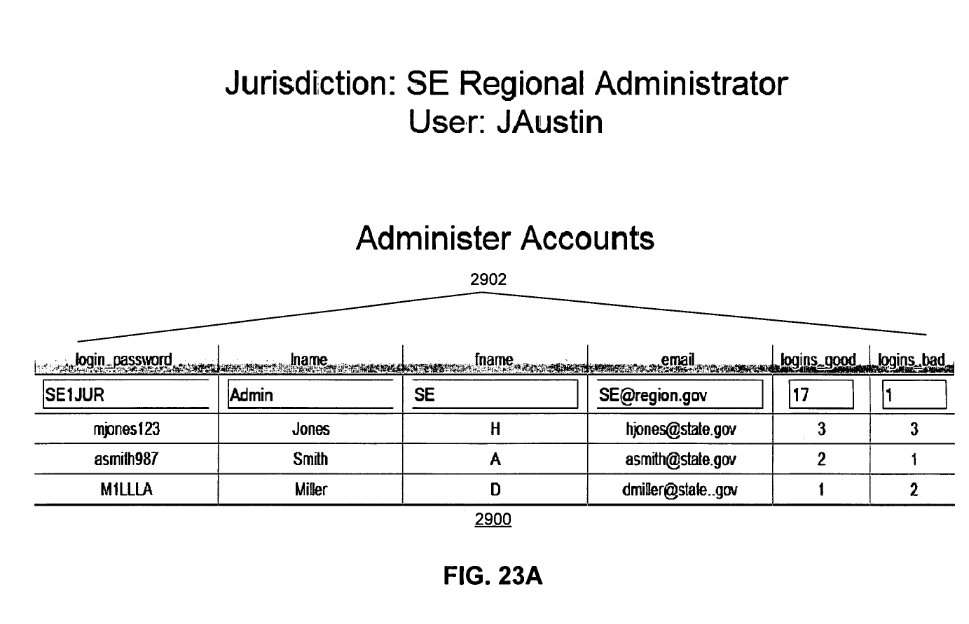

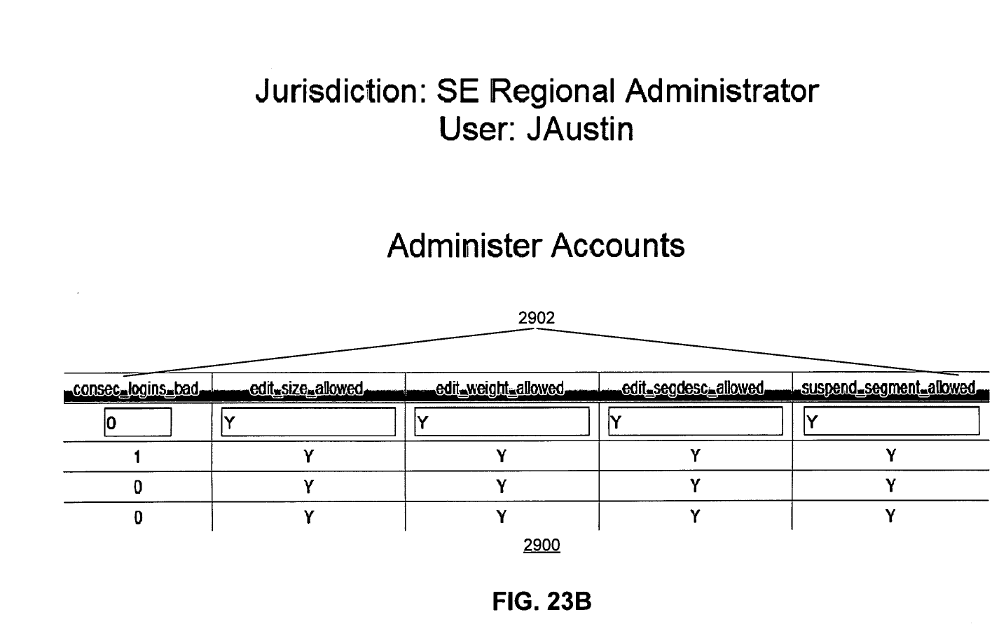

Providing that the jurisdiction and/or service entity credentials are sufficient, jurisdiction and/or service entity user accounts can be edited, including account activation or deactivation. This may be accomplished, for example, by selecting the edit link 2801 pertaining to the chosen account, which alters the view to allow the data elements corresponding to the chosen jurisdiction and/or service entity user account to be edited such as is shown in FIGS. 23, 23A, and 23B item 2900, which depict an example of an editable form of the data view with all data columns editable 2902. In the course of normal jurisdiction and/or service entity user maintenance, and depending on jurisdiction and/or service entity user permissions, certain fields may not be rendered in an editable form, such as route segment, segment collection and route activation permissions. After the appropriate changes are made to the jurisdiction and/or service entity user account details, the changes are then committed 3600 to the jurisdiction and service entity account database 114 by selecting the update function 2901, and the editable data grid is rendered as view only. If the changes are unwanted, a cancel link 2901 will render the editable data grid as view only without committing the data changes to the system jurisdiction and service entity account database 114.

### Maintain Fee Tables

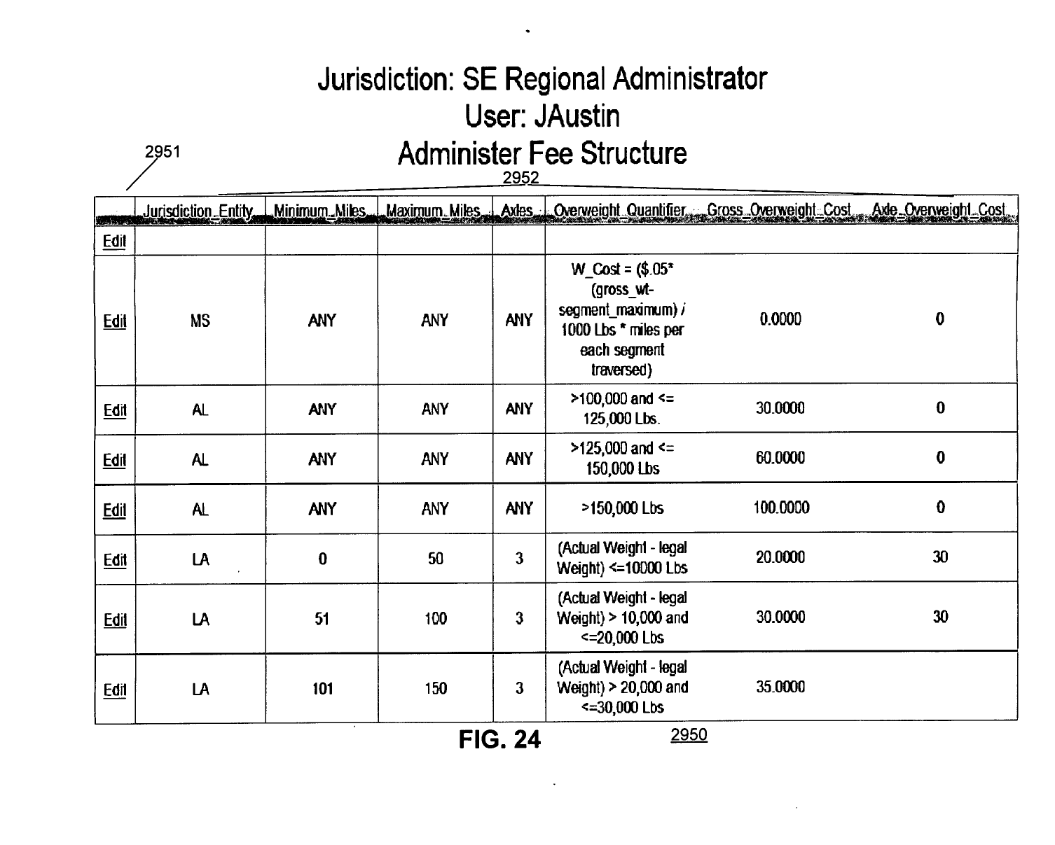

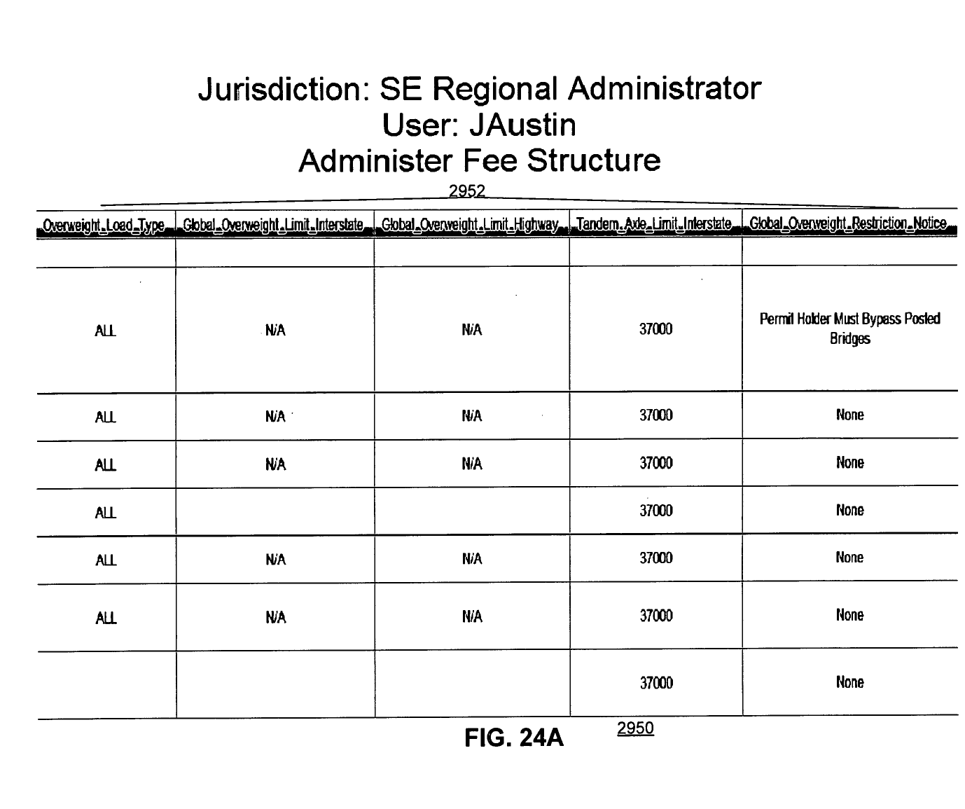

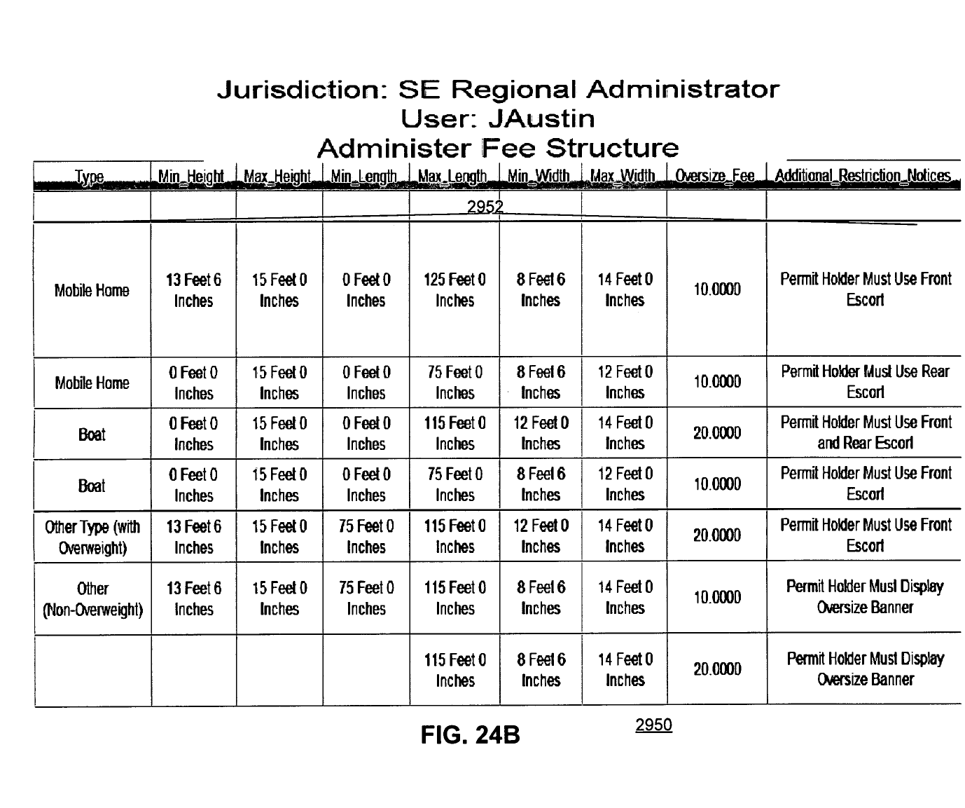

Referring to View/Edit Fee Table Function 3500, and in response to the selection of the maintain fee tables option 2052, an example of a data view illustrated in FIGS. 24, 24A and 24B, item 2950 is displayed via the application and program elements 109 indicating the jurisdiction and/or service entity fee data and/or general jurisdiction restriction notification information stored in the jurisdiction and service entity fee database 115.

Each data view column in 2950 may be sorted or reorganized to display jurisdiction and/or service entity fee information in sorted order, and/or can be filtered by criteria such as jurisdiction (e.g., MS) or fee and/or restriction information. In this non-limiting example, a regional administrator is able to view jurisdiction and/or service entity fees, notices and restrictions belonging to multiple jurisdictions, however in other instances viewable jurisdiction and/or service entity user accounts may be restricted to only those fees and/or notices and restrictions within the jurisdiction.

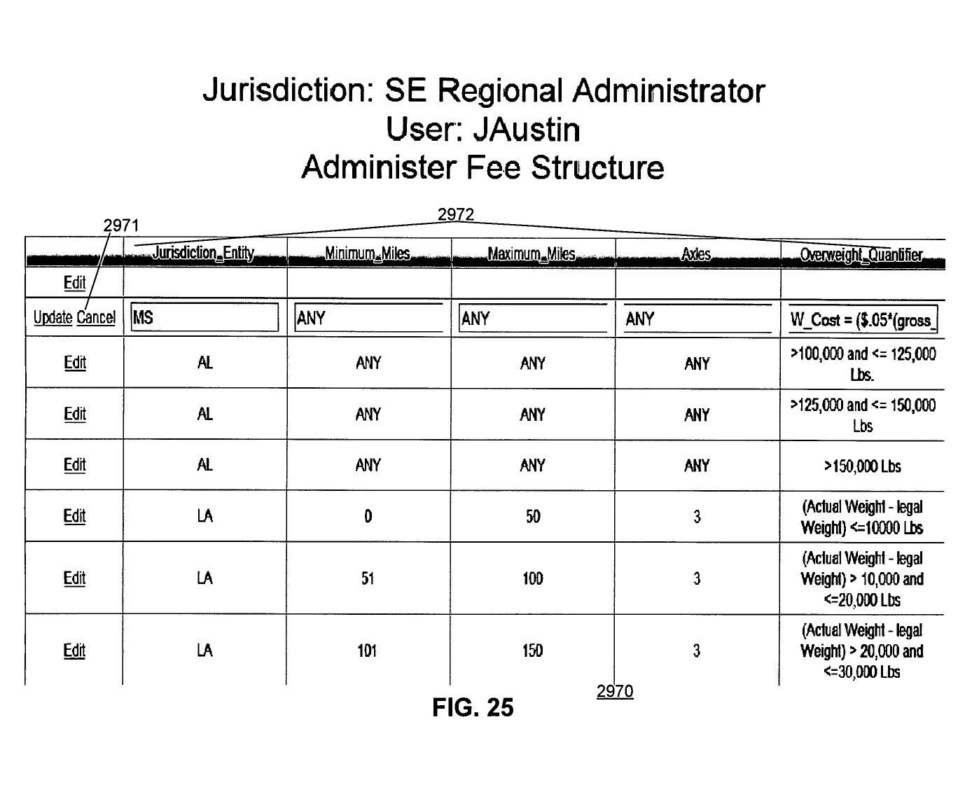

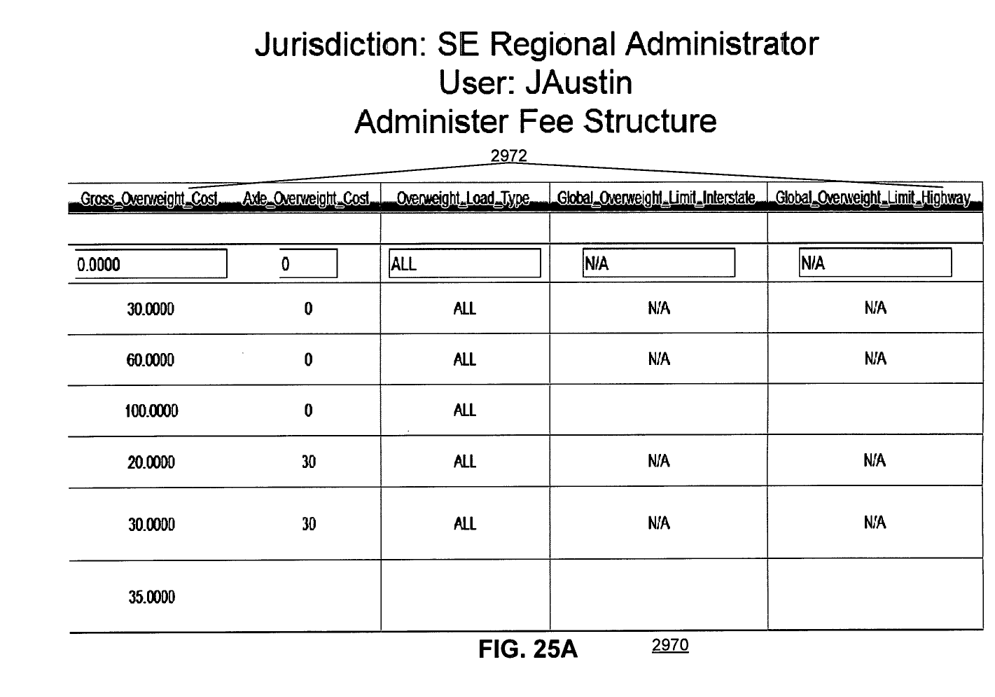

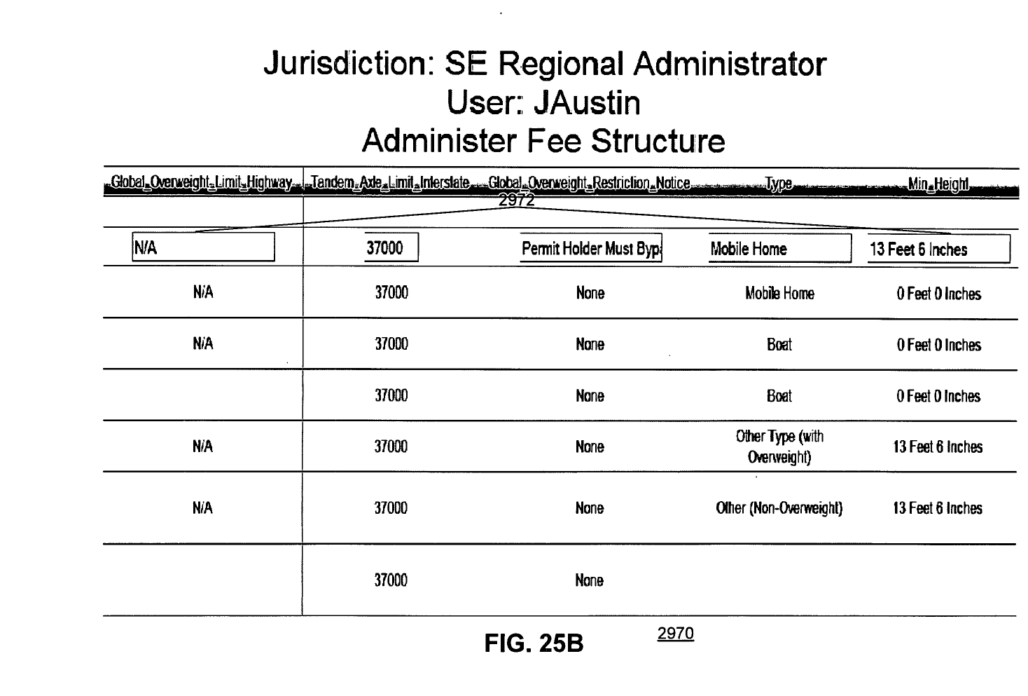

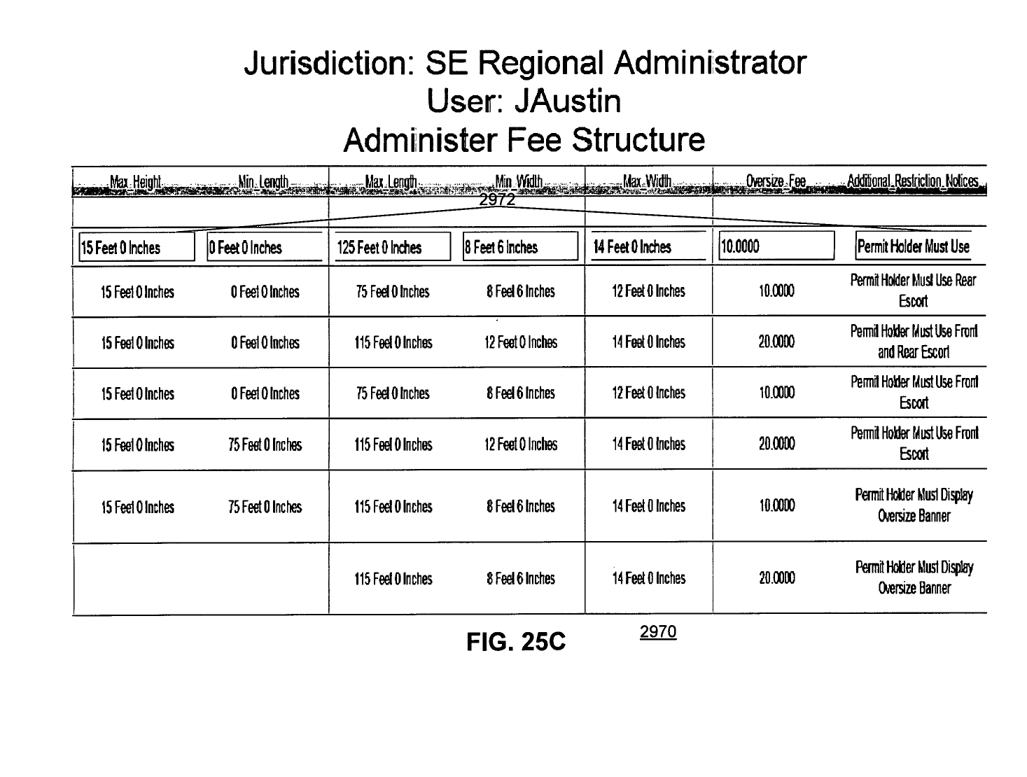

Providing the jurisdiction and/or service entity credentials are sufficient, jurisdiction and/or service entity fee data can be edited, including account notice and restriction information. This is accomplished by selecting the edit link 2951 pertaining to the chosen fee record, which alters the view to allow the data elements corresponding to the chosen jurisdiction and/or service entity user account to be edited as is shown in FIGS. 25, 25A, 25B and 25C, Item 2970, which depicts an editable form of the data view with all data columns editable 2972. In the course of normal jurisdiction and/or service entity fee maintenance, and depending on user and/or service entity permissions, certain fields may not be rendered in an editable form, such as the fee columns. After the appropriate changes are made to the displayed information, the changes are then committed to the jurisdiction and service entity fee database 115 by selecting the update function 2971, and the editable data grid is rendered as view only. If the changes are unwanted, a cancel link 2971 will render the editable data grid as view only without committing the data changes to the system jurisdiction and service entity fee database 115.

### CONCLUSION

Thus, a convenient and efficient system has been devised for allowing a jurisdiction or service entity to create, modify criteria, enable and disable individual route segments, route collections, complete routes, jurisdiction and/or service administration accounts and jurisdiction and service fee structures, as well as enabling users to determine and select appropriate routes based on vehicle criteria and to apply for, and receive permission to travel those routes. It should be noted that reference numerals in the appended method claims identifying steps are for convenience only and are not intended to imply a necessary ordering of the steps. It is, therefore, to be understood that within the scope of the appended claims the invention may be practiced otherwise than as specifically described. No claim element should be interpreted to be in means-plus-function format unless the entire phrase “means for” is explicitly recited in the claim element.

1. A method in a computing system for routing using a plurality of stored route entries that each define a route over which a vehicle may travel, each route being associated with a plurality of segments extending over different portions of the defined route, each segment having an associated vehicle criterion limit, the method comprising:
receiving an indication of an origin and a destination;
receiving a vehicle criterion;
searching the plurality of route entries for at least one route that connects the origin with the destination;
for at least some of the segments in the at least one route, determining whether those segments are each associated with a vehicle criterion limit that encompasses the vehicle criterion; and
displaying results based upon an outcome of the step of determining.

2. The method of claim 1, wherein the vehicle criterion limit is at least one of maximum vehicle height, maximum vehicle width, and maximum vehicle length.

3. The method of claim 1, wherein the vehicle criterion limit is maximum vehicle weight.

4. The method of claim 1, wherein receiving the indication of the origin and the destination comprises receiving the indication remotely over a network.

5. The method of claim 1, wherein the vehicle criterion is one of vehicle height, vehicle width, and vehicle length.

6. The method of claim 1, wherein the vehicle criterion is vehicle weight.

7. The method of claim 1, wherein the origin and the destination are in different jurisdictions.

8. One or more computer-readable storage media storing computer-executable instructions for performing a method for routing using a plurality of stored route entries that each define a route over which a vehicle may travel, each route being associated with a plurality of segments extending over different portions of the defined route, each segment having an associated vehicle criterion limit, the method comprising:
receiving an indication of an origin and a destination;
receiving a vehicle criterion;
searching the plurality of route entries for at least one route that connects the origin with the destination;
for at least some of the segments in the at least one route, determining whether those segments are each associated with a vehicle criterion limit that encompasses the vehicle criterion.

9. The one or more computer-readable media of claim 8, further storing computer-readable data representing the route entries, the segments, and the vehicle criterion limits.

10. The one or more computer-readable media of claim 8, wherein the method further comprises displaying results based upon an outcome of the step of determining

11. One or more computer-readable media storing computer-readable data representing routes that are traversable by a vehicle, the computer-readable data comprising:
first data representing a plurality of route segments, and further representing a vehicle criterion limit for each of the route segments;
second data representing a plurality of route segment collections, further representing, for each of the route segment collections, an association between the route segment collection and a subset of the route segments; and
third data representing a plurality of routes, and further representing, for each of the routes, an association between the route and one of the route segment collections.

12. The one or more computer-readable media of claim 11, wherein the second data further represents, for each of the route segment collections, a traversal order of the associated subset of the route segments.

13. The one or more computer-readable media of claim 11, wherein the vehicle criterion limit for at least some of the route segments is a maximum vehicle dimension.

14. The one or more computer-readable media of claim 11, wherein the vehicle criterion limit for at least some of the route segments is a maximum vehicle weight.

15. The one or more computer-readable media of claim 11, wherein a first subset of the plurality of route segments are in a first jurisdiction and the second subset of the plurality of route segments are in a second jurisdiction.

16. The one or more computer-readable media of claim 11, wherein the first data further represents, for at least some of the route segments, an indication of an availability of the route segment.

17. The one or more computer-readable media of claim 11, further storing computer-executable instructions for performing a method, the method comprising:
receiving an indication of an origin and a destination;
receiving a vehicle criterion;
determining from the third data a first one of the routes that connects the origin with the destination;
determining from the third data a first one of the route segment collections, the first route segment collection being associated with the first route;
determining from the second data a first subset of the route segments, the first subset being associated with the first route segment collection;
for each of the first subset of route segments, determining whether the vehicle criterion limit for that route segment encompasses the vehicle criterion.

18. The one or more computer-readable media of claim 11, further storing computer-executable instructions for performing a method, the method comprising:
allowing a first user to edit a first subset of the route segments but not a second subset of the route segments; and
allowing a second user to edit the second subset of the route segments but not the first subset of the route segments.

19. A method in a computing system for routing using a plurality of stored route entries that each define a route over which a vehicle may travel between an origin and a destination, each route being associated with a plurality of route segments extending over different portions of the defined route, each route segment having at least one associated vehicle criterion limit, the method comprising:
receiving data representing at least one vehicle criterion;
determining which of the plurality of route segments has the at least one associated vehicle criterion limit that encompasses the at least one vehicle criterion;
determining a subset of the plurality of routes, the subset of the plurality of routes being associated with those of the route segments having the at least one associated vehicle criterion limit that encompasses the at least one vehicle criterion;
determining the origin of each of the subset of the plurality of routes; and
displaying an indication of each of the determined origins.

20. The method of claim 19, further comprising:
receiving data representing a selected one of the determined origins;
determining the destination of each of the subset of the plurality of routes that has the selected origin; and
displaying an indication of each of the determined destinations.

21. The method of claim 19, wherein the at least one vehicle criterion limit for each of at least some of the route segments includes a vehicle weight limit.

22. The method of claim 20, wherein the at least one vehicle criterion limit for each of at least some of the route segments includes a vehicle dimensional limit.

23. One or more computer-readable media storing computer-executable instructions for performing a method for routing using a plurality of stored route entries that each define a route over which a vehicle may travel between an origin and a destination, each route being associated with a plurality of route segments extending over different portions of the defined route, each route segment having at least one associated vehicle criterion limit, the method comprising:
receiving data representing at least one vehicle criterion;
determining which of the plurality of route segments has the at least one associated vehicle criterion limit that encompasses the at least one vehicle criterion;
determining a subset of the plurality of routes, the subset of the plurality of routes being associated with those of the route segments having the at least one associated vehicle criterion limit that encompasses the at least one vehicle criterion;
determining the origin of each of the subset of the plurality of routes; and
displaying an indication of each of the determined origins

24. A system, comprising:
one or more computer-readable media storing:
first data representing information about roadways that are located in a first jurisdiction, and
second data representing information about roadways that are located in a second jurisdiction; and
a computing unit coupled to the one or more computer-readable media and configured to allow a first user to modify the first data but not the second data, and a second user to modify the second data but not the first data.

25. The system of claim 24, wherein the one or more computer-readable media further stores third data representing, for each of a plurality of route segments, a property of the route segment and a date range for which the property applies to the route segment.

26. The system of claim 25, wherein for each of the plurality of the route segments, the property is an inactive status or altered vehicle criterion limit of the route segment.

27. A method in a computing system for routing a vehicle, the method comprising:
receiving an indication of an origin and a destination;
receiving a vehicle criterion;
determining a routing availability independent of the vehicle criterion;
determining a routing of the vehicle based on the origin, the destination, the vehicle criterion, and the routing availability; and
displaying results based upon an outcome of the step of determining.

28. The method of claim 27, wherein determining the routing availability comprises determining the routing availability based upon an availability of one or more route segments.

29. The method of claim 27, wherein determining the routing and the routing availability comprises determining the routing and the routing availability based on routing data, the method further comprising:
allowing a first user to modify a first subset of the routing data but not a second subset of the routing data, the first subset of the routing data representing information about roadways that are located in a first jurisdiction, and the second subset of the routing data representing information about roadways that are located in a second jurisdiction; and
allowing a second user to edit the second subset of the routing data but not the first subset of the routing data.

30. One or more computer-readable media storing computer-readable data representing roadways that are traversable by a vehicle, the computer-readable data comprising:
first data representing information about roadways located in a plurality of jurisdictions; and
for each of a plurality of users, second data associating the respective user with only one of the plurality of jurisdictions and with data maintenance rights for the jurisdiction with which the user is associated.

31. The one or more computer-readable media of claim 30, wherein the second data comprises, for each of the plurality of users, an indication of whether the user is allowed to inactivate a portion of the first data in the jurisdiction with which the user is associated.

32. The one or more computer-readable media of claim 30, wherein for each of the plurality of jurisdictions, the first data further comprises an indication of at least one vehicle criterion limit, and wherein the second data comprises, for each of the plurality of users, an indication of whether the user is allowed to modify the at least one vehicle criterion limit for the jurisdiction with which the user is associated.
